(19) United States
(12) Patent Application Publication
(10) Pub. No.: US 2008/0139141 A1
(43) Pub. Date: Jun. 12, 2008

(54) METHOD AND SYSTEM FOR ESTIMATING AND COMPENSATING NON-LINEAR DISTORTION IN A TRANSMITTER USING DATA SIGNAL FEEDBACK

(76) Inventors: George Varghese, Kottayam District (IN); Pankaj Saxena, Bhopal (IN); Sreenivas Karanam, Bangalore (IN); Sudhindra Bellary, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/777,543

(22) Filed: Jul. 13, 2007

Related U.S. Application Data
(60) Provisional application No. 60/868,818, filed on Dec. 6, 2006.

(51) Int. Cl. H04B 1/04

(52) U.S. Cl. 455/114.3

(57) ABSTRACT

Aspects of a method and system for estimating and compensating for non-linear distortion in a transmitter using data signal feedback are presented. Aspects of the system may include a method and system by which predistortion values, for compensating for non-linear distortion, may be computed based on feedback signals generated in response to wideband input signals. The wideband input signals may comprise a plurality of frequency components and/or signal amplitudes. The predistortion values may be computed by time-synchronizing a wideband input signal generated at a given time instant, and the feedback signal generated at a subsequent time instant in response. A predistortion function may be computed by computing predistortion values for a plurality of signal amplitude values and/or IC operating temperatures. The computed values may be stored in a lookup table and retrieved to predistort subsequent wideband input signals based on the amplitude of the signals and/or the IC operating temperature.

### CROSS-REFERENCE TO RELATED APPLICATIONS/INCORPORATION BY REFERENCE

This application makes reference to, claims priority to, and claims the benefit of U.S. Provisional Application Ser. No. 60/868,818, filed on Dec. 6, 2006.

This application makes reference to U.S. application Ser. No. 11/618,876, filed on Dec. 31, 2006.

Each of the above stated applications is hereby incorporated herein by reference in its entirety.

### FIELD OF THE INVENTION

Certain embodiments of the invention relate to wireless communications. More specifically, certain embodiments of the invention relate to a method and system for estimating and compensating for non-linear distortion in a transmitter using data signal feedback.

### BACKGROUND OF THE INVENTION

A power amplification circuit in a wireless system is typically a large signal device. In wireless local area network (WLAN) systems, the power amplifier circuit may transmit output signals at average power levels in the range of 10 dBm to 15 dBm, and peak power levels of about 25 dBm, for example. In WLAN systems, which use OFDM or CCK modulation, output power levels may vary widely such that the ratio of the peak power level to the average power level may be large, for example, 12 dB for OFDM and 6 dB for CCK. Because of these large swings in output power levels, power amplifier (PA) circuits may distort the output signal. Distortion, however, is a characteristic, which may be observed in PA circuits that are utilized across a wide range of applications, and may not be limited to PA circuits utilized in wireless systems. There are two metrics, which may be utilized to evaluate the distortion performance of PA circuits. These metrics may be referred to as amplitude modulation to amplitude modulation (AM-AM) distortion, and amplitude modulation to phase modulation (AM-PM) distortion.

The AM-AM distortion provides a measure of the output power level, pₒᵤₜ, in response to the input power level, pᵢₙ. The input power level, and output power level are each typically measured in units of dBm, for example. In an ideal, non-distorting, PA circuit, the output power level changes linearly in response to a change in the input power level. Thus, for each Δpᵢₙ change in the input power level there may be a corresponding change in the output power level Δpₒᵤₜ. The AM-AM distortion may be observed when, for example, the output power level in response to a first input power level may be pₒᵤₜ₁≈αpᵢₙ₁, where the output level in response to a second input power level may be pₒᵤₜ₂≈βpᵢₙ₂, when α≠β. Further α and β are assumed to be functions of pᵢₙ₁ and pᵢₙ₂

The AM-PM distortion provides a measure of the phase of the output signal in relation to the input signal (or output phase) in response to the input power level. Output phase is typically measured in units of angular degrees. The AM-PM distortion may be observed when, for example, the input to output phase-change varies in response to a change in input power level.

Limitations in the performance of PA circuitry due to distortion may be exacerbated when the PA is integrated in a single integrated circuit (IC) device with other radio frequency (RF) transmitter circuitry [such as digital to analog converters (DAC), low pass filters (LPF), mixers, and RF programmable gain amplifiers (RFPGA)]. Whereas the pressing need to increase the integration of functions performed within a single IC, and attendant increase in the number of semiconductor devices, may push semiconductor fabrication technologies toward increasingly shrinking semiconductor device geometries, these very semiconductor fabrication technologies may impose limitations on the performance of the integrated PA circuitry. For example, utilizing a 65 nm CMOS process may restrict the range of input power levels for which the PA provides linear output power level amplification.

AM-AM distortion and/or AM-PM distortion may be exacerbated by changing in operating temperature within an IC device. For example, the gain of the PA for a given input signal power level, pᵢₙ, may decrease as the operating temperature increases. The amount of change in PA gain as a function of operating temperate may itself vary as a function of the input signal power level. Consequently, AM-AM distortion for a PA may vary as a function of operating temperature within the IC device.

Similarly AM-PM distortion may change as a function of operating temperature within the IC device. Furthermore, AM-PM distortion may also vary as a function of the input signal power level.

The AM-AM distortion and/or the AM-PM distortion comprise transmitter impairments that may result in signal transmission errors that may result in unintentional and/or undesirable modifications in the magnitude and/or phase of transmitted signals. When transmitting quadrature RF signals, the AM-AM distortion and/or the AM-PM distortion may cause unintentional and/or undesirable modifications in the magnitude and/or phase of the I components and/or Q components in the transmitted signals.

The transmission of erroneous signals from an RF transmitter may result in erroneous detection of data contained within the received signals at an RF receiver. The result may be reduced communications quality as measured, for example, by packet error rate (PER), and/or bit error rate (BER).

Communications standards may specify a limit for Error Vector Magnitude (EVM) in a transmitted signal. For example, IEEE 802.11g standard for WLAN communications specifies that EVM_{dB} for a 54 Mbps transmitted signal may be no greater than −25 dB. Thus, some conventional RF transmitters may be required to limit the peak power level for signals generated by the PA to ensure that the transmitted signals comply with EVM specifications. One potential limitation imposed by the reduced output power level is the reduced operating range in wireless communications. In this regard, the EVM specification may reduce the allowable distance between a transmitting antenna and a receiving antenna for which signals may be transmitted from an RF transmitter and received by an RF receiver, in relation to the operating range that would be theoretically possible if the RF transmitter were able to transmit signals at the maximum, or saturation, output power level that could be generated by the PA.

A spectral mask typically defines allowable radio (or optical) transmission levels across a frequency band. Spectral mask requirements are typically specified such that signal transmissions, which utilize a given frequency band do not insert spurious, or interfering emissions into signal transmissions, which utilize another frequency band, for example an adjacent frequency band. Various communications standards may specify spectral mask requirements. However, while amplifying an input signal, some non-linear PA circuits may generate intermodulation signal components which insert spurious emissions that violate applicable spectral mask requirements.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for estimating and compensating for non-linear distortion in a transmitter using data signal feedback, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating and exemplary mobile terminal, which may be utilized in connection with an embodiment of the invention.

FIG. 2 is an exemplary block diagram illustrating a single chip RF transmitter and receiver utilizing a single feedback mixer, which may be utilized in connection with an embodiment of the invention.

FIG. 3 is a block diagram of an exemplary system for estimating and compensating non-linear distortion in a transmitter using quadrature feedback signals, in accordance with an embodiment of the invention.

FIG. 4 is a block diagram of an exemplary system for estimating and compensating non-linear distortion in a transmitter using a single feedback signal, in accordance with an embodiment of the invention.

FIG. 5 is an exemplary block diagram of a predistorter, in accordance with an embodiment of the invention.

FIG. 6 is an exemplary block diagram of a lookup table update module, in accordance with an embodiment of the invention.

FIG. 7 is an exemplary block diagram of a synchronizer, in accordance with an embodiment of the invention.

FIG. 8 is an exemplary block diagram of a synchronizer tap update block, in accordance with an embodiment of the invention.

FIG. 9 is an exemplary block diagram of an interpolator block, in accordance with an embodiment of the invention.

FIG. 10 is an exemplary block diagram of a correlator, in accordance with an embodiment of the invention.

FIG. 11 is a flowchart illustrating exemplary steps for a quad signal combiner with reception of normal data transmission, in accordance with an embodiment of the invention.

FIG. 12 is a flowchart illustrating exemplary steps for a quad signal combiner with reception of training signals, in accordance with an embodiment of the invention.

FIG. 13A presents a series of graphs illustrating exemplary predistortion magnitude values, in accordance with an embodiment of the invention.

FIG. 13B presents a series of graphs illustrating exemplary predistortion phase values, in accordance with an embodiment of the invention.

FIG. 14 is a flowchart illustrating exemplary steps for estimating and compensating non-linear distortions in a transmitter using feedback signals, according to an embodiment of the invention.

### DETAILED DESCRIPTION OF THE INVENTION

Certain embodiments of the invention may be found in a method and system for estimating and compensating for non-linear distortion in a transmitter using data signal feedback. Various embodiments of the invention may comprise a method and system by which predistortion values, for compensating for non-linear distortion, may be computed based on feedback signals generated in response to wideband input signals. The wideband input signals may comprise a plurality of frequency components and/or signal amplitudes. In an exemplary embodiment of the invention, the wideband input signal may be an orthogonal frequency division multiplexing (OFDM) signal comprising a plurality of data symbols modulated by a plurality of frequency carrier signals spanning a range of frequencies. In another exemplary embodiment of the invention, the wideband signal may be a training signal, which comprises a range of frequency signals to meet spectral density requirements under applicable standards. The predistortion values may be computed by time-synchronizing a wideband input signal generated at a given time instant, and the feedback signal generated at a subsequent time instant in response. Once the signals are time-synchronized, a predistortion value may be computed. A predistortion function may be computed by computing predistortion values for a plurality of signal amplitude values and/or IC operating temperatures. In an exemplary embodiment of the invention, the computed values may be stored in a lookup table (LUT) and retrieved to predistort subsequent wideband input signals based on the amplitude of the signals and/or the IC operating temperature. Stored predistortion values may be dynamically modified and updated by repeating the computation of predistortion values by generating subsequent feedback signals based on the predistorted subsequent wideband input signals.

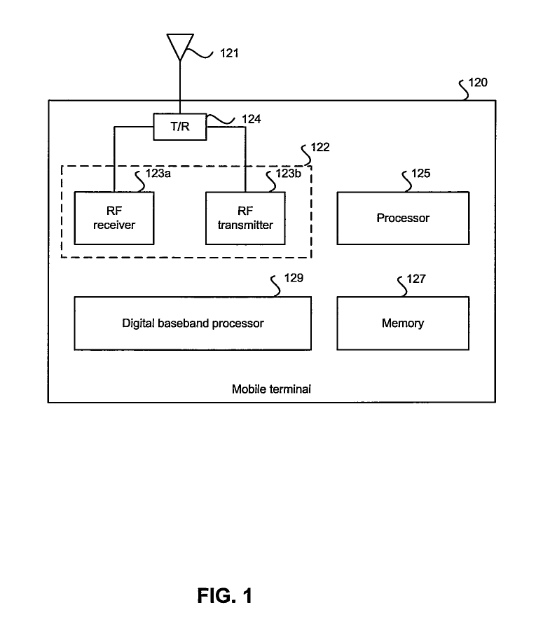

FIG. 1 is a block diagram illustrating and exemplary mobile terminal, which may be utilized in connection with an embodiment of the invention. Referring to FIG. 1, there is shown mobile terminal 120 that may comprise an RF receiver 123a, an RF transmitter 123b, a digital baseband processor 129, a processor 125, and a memory 127. In some embodiments of the invention, the RF receiver 123a, and RF transmitter 123b may be integrated into an RF transceiver 122, for example. A single transmit and receive antenna 121 may be communicatively coupled to the RF receiver 123a and the RF transmitter 123b. A switch 124, or other device having switching capabilities may be coupled between the RF receiver 123a and RF transmitter 123b, and may be utilized to switch the antenna 121 between transmit and receive functions.

The RF receiver 123a may comprise suitable logic, circuitry, and/or code that may enable processing of received RF signals. The RF receiver 123a may enable receiving RF signals in frequency bands utilized by various wireless communication systems, such as WLAN, Bluetooth, GSM and/or CDMA, for example.

The digital baseband processor 129 may comprise suitable logic, circuitry, and/or code that may enable processing and/or handling of baseband signals. In this regard, the digital baseband processor 129 may process or handle signals received from the RF receiver 123a and/or signals to be transferred to the RF transmitter 123b for transmission via a wireless communication medium. The digital baseband processor 129 may also provide control and/or feedback information to the RF receiver 123a and to the RF transmitter 123b, based on information from the processed signals. The digital baseband processor 129 may communicate information and/or data from the processed signals to the processor 125 and/or to the memory 127. Moreover, the digital baseband processor 129 may receive information from the processor 125 and/or to the memory 127, which may be processed and transferred to the RF transmitter 123b for transmission via the wireless communication medium.

The RF transmitter 123b may comprise suitable logic, circuitry, and/or code that may enable processing of RF signals for transmission. The RF transmitter 123b may enable transmission of RF signals in frequency bands utilized by various wireless communications systems, such as GSM and/or CDMA, for example.

The processor 125 may comprise suitable logic, circuitry, and/or code that may enable control and/or data processing operations for the mobile terminal 120. The processor 125 may be utilized to control at least a portion of the RF receiver 123a, the RF transmitter 123b, the digital baseband processor 129, and/or the memory 127. In this regard, the processor 125 may generate at least one signal for controlling operations within the mobile terminal 120.

The memory 127 may comprise suitable logic, circuitry, and/or code that may enable storage of data and/or other information utilized by the mobile terminal 120. For example, the memory 127 may be utilized for storing processed data generated by the digital baseband processor 129 and/or the processor 125. The memory 127 may also be utilized to store information, such as configuration information, which may be utilized to control the operation of at least one block in the mobile terminal 120. For example, the memory 127 may comprise information necessary to configure the RF receiver 123a to enable receiving RF signals in the appropriate frequency band.

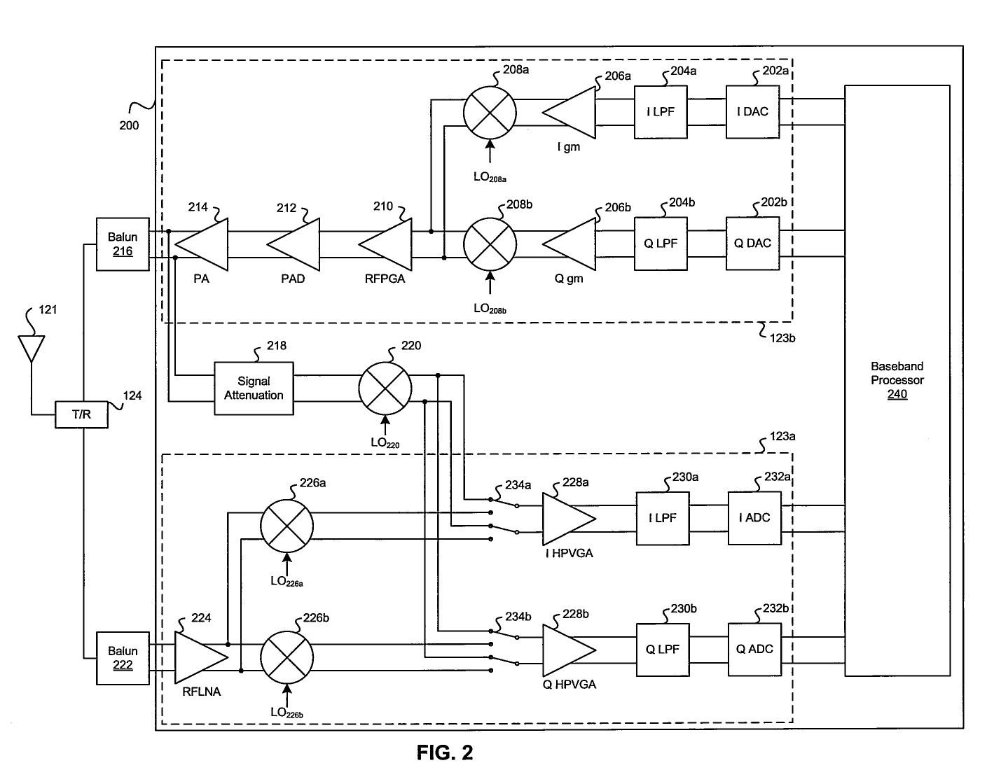

FIG. 2 is an exemplary block diagram illustrating a single chip RF transmitter and receiver utilizing a single feedback mixer, which may be utilized in connection with an embodiment of the invention. Referring to FIG. 2, there is shown a single chip RF transceiver 200, baluns 216 and 222, switch 124, and antenna 121. The single chip RF transceiver 200 may comprise an RF receiver 123a, an RF transmitter 123b, a signal attenuation block 218, a feedback mixer 220, and a baseband processor 240. The RF transmitter 123b may comprise a power amplifier (PA) 214, a power amplifier driver (PAD) 212, an RF programmable gain amplifier (RFPGA) 210, a transmitter In-phase signal (I) mixer 208a, a transmitter Quadrature-phase signal (Q) mixer 208b, an I transconductance amplifier (gm) 206a, a Q gm 206b, an I low pass filter (LPF) 204a, a Q LPF 204b, an I digital to analog converter (I DAC) 202a, and a Q DAC 202b. The RF receiver 123a may comprise an RF low noise amplifier (RFLNA) 224, a receiver I mixer 226a, a receiver Q mixer 226b, an I path selector switch 234a, a Q path selector switch 234b, an I high pass variable gain amplifier (HPVGA) 228a, a Q HPVGA 228b, an I LPF 230a, a Q LPF 230b, an I analog to digital converter (DAC) 232a, and a Q DAC 232b.

The signal attenuation block 218 may comprise suitable logic, circuitry, and/or code that may enable generation of an output signal, the amplitude and/or power level of which may be based on an input signal after insertion of a specified level of attenuation. In various embodiments of the invention the attenuation level may be programmable over a range of attenuation levels. In an exemplary embodiment of the invention, the range of attenuation levels may comprise −32 dB to −40 dB, although various embodiments of the invention may not be limited to such a specific range. In an exemplary embodiment of the invention, the signal attenuation block 218 may receive a differential input signal and output a differential output signal.

The feedback mixer 220 may comprise suitable logic, circuitry, and/or code that may enable downconversion of an input signal. The feedback mixer 220 may utilize an input local oscillator signal labeled as LO₂₂₀ (in FIG. 2) to downconvert the input signal. The input signal may be an upconverted RF signal. In an exemplary embodiment of the invention, the feedback mixer 220 may receive a differential input signal and output a differential output signal.

The PA 214 may comprise suitable logic, circuitry, and/or code that may enable amplification of input signals to generate a transmitted signal of sufficient signal power (as measured by dBm, for example) for transmission via a wireless communication medium. In an exemplary embodiment of the invention, the PA 214 may receive a differential input signal and output a differential output signal.

The PAD 212 may comprise suitable logic, circuitry, and/or code that may enable amplification of input signals to generate an amplified output signal. The PAD 212 may be utilized in multistage amplifier systems wherein the output of the PAD 212 may be an input to a subsequent amplification stage. In an exemplary embodiment of the invention, the PAD 212 may receive a differential input signal and output a differential output signal.

The RFPGA 210 may comprise suitable logic, circuitry, and/or code that may enable amplification of input signals to generate an amplified output signal, wherein the amount of amplification, as measured in dB, may be determined based on an input control signal. In various embodiments of the invention, the input control signal may comprise binary bits. In an exemplary embodiment of the invention, the RFPGA 210 may receive a differential input signal and generate a differential output signal.

The transmitter I mixer 208a may comprise suitable logic, circuitry, and/or code that may enable generation of an RF signal by upconversion of an input signal. The transmitter I mixer 208a may utilize an input local oscillator signal labeled as LO₂₀₈ₐ to upconvert the input signal. The upconverted signal may be an RF signal. The transmitter I mixer 208a may produce an RF signal for which the carrier frequency may be equal to the frequency of the signal LO₂₀₈ₐ. In an exemplary embodiment of the invention, the transmitter I mixer 208a may receive a differential input signal and generate a differential output signal.

The transmitter Q mixer 208b may be substantially similar to the transmitter I mixer 208a. The transmitter Q mixer 208b may utilize an input local oscillator signal labeled as LO_{208b} in quadrature to LO₂₀₈ₐ (in FIG. 2) to upconvert the input signal.

The I gm 206a may comprise suitable, logic, circuitry, and/or code that may enable generation of an output current, the amplitude of which may be proportional to an amplitude of an input voltage, wherein the measure of proportionality may be determined based on the transconductance parameter, gm_{I}, associated with the I gm 206a. In an exemplary embodiment of the invention, the I gm 206a may receive a differential input signal and output a differential output signal.

The Q gm 206b may be substantially similar to the I gm 206a. The transconductance parameter associated with the Q gm 206b is gm_{Q}.

The I LPF 204a may comprise suitable logic, circuitry, and/or code that may enable selection of a cutoff frequency, wherein the LPF may attenuate the amplitudes of input signal components for which the corresponding frequency is higher than the cutoff frequency, while the amplitudes of input signal components for which the corresponding frequency is less than the cutoff frequency may “pass,” or not be attenuated, or attenuated to a lesser degree than input signal components at frequencies higher than the cutoff frequency. In various embodiments of the invention, the I LPF 210a may be implemented as a passive filter, such as one that utilizes resistor, capacitor, and/or inductor elements, or implemented as an active filter, such as one that utilizes an operational amplifier. In an exemplary embodiment of the invention, the I LPF 210a may receive a differential input signal and output a differential output signal. The Q LPF 204b may be substantially similar to the I LPF 204a. The I LPF 230a and Q LPF 230b may be substantially similar to the I LPF 204a.

The I DAC 202a may comprise suitable logic, circuitry, and/or code that may enable conversion of an input digital signal to a corresponding analog representation. The Q DAC 202b may be substantially similar to the I DAC 202a.

The RFLNA 224 may comprise suitable logic, circuitry, and/or code that may enable amplification of weak signals (as measured by dBm, for example), such as received from an antenna. The input signal may be an RF signal received at an antenna, which is communicatively coupled to the RFLNA 224. In an exemplary embodiment of the invention, the RFLNA 224 may receive a differential input signal and output a differential output signal.

The receiver I mixer 226a may comprise suitable logic, circuitry, and/or code that may enable downconversion of an input signal. The receiver I mixer 226a may utilize an input local oscillator signal labeled as LO₂₂₆ₐ (in FIG. 2) to downconvert the input signal. The input signal may be an RF signal that may be downconverted to generate a baseband signal, or an intermediate frequency (IF) signal. In an exemplary embodiment of the invention, the receiver I mixer 226a may receive a differential input signal and output a differential output signal.

The receiver Q mixer 226b may be substantially similar to the receiver I mixer 226a. The receiver Q mixer 226b may utilize an input local oscillator signal labeled as LO_{226b} (in FIG. 2) to downconvert the input signal. In various embodiments of the invention, the local oscillator signal LO_{226b} may be a phase shifted version of the local oscillator signal LO₂₂₆ₐ.

The I path selector switch 234a may comprise suitable logic, circuitry, and/or code that may enable an input signal to be selectively coupled to one of a plurality of output points. In an exemplary embodiment of the invention, the I path selector switch 234a may select from two pairs of differential input signals, and couple the selected differential input signal to a differential output. The Q path selector switch 234b may be substantially similar to the I path selector switch 234a.

The I HPVGA 228a may comprise suitable logic, circuitry and/or code that may enable amplification of input signals to generate an amplified output signal, wherein the amount of amplification, as measured in dB for example, may be determined based on an input control signal. In various embodiments of the invention, the input control signal may comprise binary bits. In addition, the I HPVGA 228a may comprise high pass filter circuitry. The high pass filter circuitry may enable the removal of DC components in the input signal, when generation the output signal. In various embodiments of the invention, the I HPVGA 228a may provide amplification levels that range from 0 dB to 30 dB. In an exemplary embodiment of the invention, the I HPVGA 228a may receive a differential input signal and output a differential output signal.

The I ADC 232a may comprise suitable logic, circuitry, and/or code that may enable conversion of an input analog signal to a corresponding digital representation. The I ADC 232a may receive an input analog signal, which may be characterized by a signal amplitude, and generate a digital output signal. In an exemplary embodiment of the invention, the I ADC 232a may receive a differential input signal and output a digital signal. The Q ADC 232b may be substantially similar to the I ADC 232a.

The baseband processor 240 may comprise suitable logic, circuitry, and/or code that may enable processing of binary data contained within an input baseband signal. The baseband processor 240 may perform processing tasks, which correspond to one or more layers in an applicable protocol reference model (PRM). For example, the baseband processor 240 may perform physical (PHY) layer processing, layer 1 (L1) processing, medium access control (MAC) layer processing, logical link control (LLC) layer processing, layer 2 (L2) processing, and/or higher layer protocol processing based on input binary data. The processing tasks performed by the baseband processor 240 may be referred to as being within the digital domain. The baseband processor 240 may also generate control signals based on the processing of the input binary data. In an exemplary embodiment of the invention, the baseband processor 240 may receive digital input signals from DAC and output digital output signals to ADC.

In operation, the baseband processor 240 may generate data comprising a sequence of bits to be transmitted via a wireless communications medium. The baseband processor 240 may generate control signals that configure the RF transmitter 123b to transmit the data. The baseband processor 240 may send a portion of the data, an I_{BB} signal, to the I DAC 202a, and another portion of the data, a Q_{BB} signal, to the Q DAC 202b. The I DAC 202a may receive a sequence of bits and generate an analog signal. The Q DAC 202b may similarly generate an analog signal.

The analog signals generated by the I DAC 202a and Q DAC 202b may comprise undesirable frequency components. The I LPF 204a and Q LPF 204b may attenuate signal amplitudes associated with these undesirable frequency components in signals generated by the I DAC 202a and Q DAC 202b respectively. The baseband processor 240 may configure the transmitter I mixer 208a to select a frequency for the LO₂₀₈ₐ signal utilized to upconvert the filtered signal from the I LPF 204a. The upconverted signal output from the transmitter I mixer 208a may comprise an I component RF signal. The baseband processor 240 may similarly configure the transmitter Q mixer 208b to generate a Q component RF signal from the filtered signal from the Q LPF 204b.

The RFPGA 210 may amplify the I component and Q component RF signals to generate a quadrature RF signal, wherein the level of amplification provided by the RFPGA 210 may be configured based on control signals generated by the baseband processor 240. The PAD 212 may provide a second stage of amplification for the signal generated by the RFPGA 210, and the PA 214 may provide a third stage of amplification for the signal generated by the PAD 212. The amplified signal from the PA 214 may be transmitted to the wireless communications medium via the antenna 121.

The baseband processor 240 may configure the RF receiver 123a and/or RF transmitter 123b for two modes of operation comprising a normal operating mode, and a calibration mode. In the normal operating mode, the RF transmitter 123b may transmit RF signals via the antenna 121, while the RF receiver 123a may receive RF signals via the antenna 121. In the calibration mode, the RF signal output from the RF transmitter 123b may be attenuated, downconverted, and inserted in the RF receiver 123a as a feedback signal. Thus, the calibration mode may enable a closed feedback loop from the baseband processor 240, to the RF transmitter 123b, to a feedback point within the RF receiver 123a, and back to the baseband processor 240.

In a normal operating mode, the baseband processor 240 may generate control signals that enable configuration of the I path selector switch 234a such that I path selector switch 234a may be configured to select an input from the receiver I mixer 226a. The I path selector switch 234a may enable the output signal from the I mixer 226a to be coupled to an input to the I HPVGA 228a. The baseband processor 240 may also generate control signals that enable configuration of the Q path selector switch 234b such that Q path selector switch 234b may be configured to select an input from the receiver Q mixer 226b. The Q path selector switch 234b may enable the output signal from the Q mixer 226b to be coupled to an input to the Q HPVGA 228b.

In the normal operating mode, the RF receiver 123a may receive RF signals via the antenna 121. The RFLNA 224 may amplify the received RF signal, which may then be sent to the receiver I mixer 226a and/or receiver Q mixer 226b. The receiver I mixer 226a may downconvert the amplified RF signal. Similarly, the receiver Q mixer 226b may also downconvert the amplified RF signal.

The baseband processor 240 may generate control signals that configure the I HPVGA 228a to amplify a portion of the downconverted signal Output₂₂₆ₐ. In an exemplary embodiment of the invention, the I HPVGA 228a may amplify signal components for which the corresponding frequency may be far from DC. Similarly, the baseband processor 240 may generate control signals that configure the Q HPVGA 228b to amplify a portion of the downconverted signal Output_{226b}.

The I LPF 230a may filter the amplified signal received from the I HPVGA 228a such that the output of the I LPF 230a is a baseband signal. The baseband signal may comprise a sequence of symbols. Similarly, the Q LPF 230b may generate a baseband signal. The I ADC 232a may convert an amplitude of a symbol in the baseband signal received from the I LPF 230a to a sequence of bits. Similarly, the Q ADC 232b may convert an amplitude of a symbol in the baseband signal received from the Q LPF 230b to a sequence of bits. The baseband processor 240 may receive the sequence of bits from the I ADC 232a and Q ADC 232b and perform various processing tasks as set forth above.

In the calibration mode, the baseband processor 240 may generate control signals that enable configuration of the I path selector switch 234a and/or Q path selector switch 234b such that I path selector switch 234a and/or Q path selector switch 234b may be configured to select an input from the feedback mixer 220. The I path selector switch 234a may enable the output signal from the feedback mixer 220 to be coupled to an input to the I HPVGA 228a. The Q path selector switch 234b may enable the output signal from the feedback mixer 220 to be coupled to an input to the Q HPVGA 228b. In the exemplary block diagram shown in FIG. 2, the I path selector switch 234a and Q path selector switch 234b are each configured to couple an input signal from the feedback mixer 220, to the inputs for the I HPVGA 228a, and Q HPVGA 228b.

In the calibration mode, the output signal from the PA 214 may be input to the signal attenuation block 218. The signal attenuation block 218 may adjust the amplitude of the RF signal generated by the PA 214 to a level more suitable for input to the feedback mixer 220. The signal attenuation block 218 may be configured by the baseband processor 240 to apply a specified attenuation level to the input signal from the PA 214. In an exemplary embodiment of the invention, for which the gain of the PA 214 may be equal to kₗᵢₙ when the PA 214 is operating in a linear operating region, the signal attenuation block 218 may be configured to apply an attenuation level equal to 1/kₗᵢₙ. Thus, the amplitude of the attenuated RF signal may be about equal to the amplitude of the input baseband signals generated by the baseband processor 240. The feedback mixer 220 may downconvert an attenuated RF signal to generate an Output₂₂₀ signal. In the calibration mode, the I HPVGA 228a and/or Q HPVGA 228b may receive input signals from the feedback mixer 220.

The I LPF 230a may filter the amplified signal received from the I HPVGA 228a such that the output of the I LPF 230a may be based on the baseband component of the Output₂₂₀ signal. Similarly, the Q LPF 230b may generate a baseband signal. The I ADC 232a may convert the output signal received from the I LPF 230a to generate a digital feedback signal I_{FB}. Similarly, the Q ADC 232b may convert the output signal received from the Q LPF 230b to generate a digital feedback signal Q_{FB}. The baseband processor 240 may receive the digital feedback signals I_{FB} and Q_{FB}.

One limitation of the PA 214 is that the output signal may become increasingly distorted as the output power level from the PA 214 increases and/or as the operating temperature of the chip changes. The distortion in the output signal from the PA 214 may be detected through AM-AM distortion measurements, and/or AM-PM distortion measurements.

For input signals, x, to the PA 214 for which the input amplitude is less than a reference level, α, the output signal from the PA 214, y, may change linearly in response to changes in the input signal x. As represented in the following equation:

y=k·x [1]

where the gain for the PA 214 k=constant for |x|≦α. Thus, for |x|≦α the PA 214 may operate in a linear operating region in which AM-AM distortion may be negligible to approximately zero. Thus, for input signals x₁ and x₂, where:

x₂=β·x₁ [2]

it follows that:

y₁=k·x₁ [3a]

y₂=k·x₂ [3b]

$$\frac{{y}_{2}}{{y}_{1}} = \frac{k \cdot {x}_{2}}{k \cdot {x}_{1}} = \frac{{x}_{2}}{{x}_{1}} = \frac{β \cdot {x}_{1}}{{x}_{1}} = β \qquad [ 3 c ]$$

and

y₂=β·y₂ [3d]

where β=constant.

### Equation [3d] shows the output signal y, which changes linearly in response to changes in the input signal x (as shown in Equation [2]).

However, for input amplitudes |x|>α the PA 214 may operate in a non-linear operating region in which AM-AM distortion is no longer negligible. In this regard, the gain k(|x|) may vary as a function of the input amplitude |x|. Thus, for input signals x₁ and x₂, where |x₁|≠|x₂|:

k(|x₁|)≠k(|x₂|) [4]

### Where the relationship between x₁ and x₂ is expressed as shown in Equation [2] under the condition β≠1:

$$\begin{matrix}{y}_{1} = k ( \vert {x}_{1} \vert ) \cdot {x}_{1} & [ 5 a ] \\ {y}_{2} = k ( \vert {x}_{2} \vert ) \cdot {x}_{2} & [ 5 b ] \\ \frac{{y}_{2}}{{y}_{1}} = \frac{k ( \vert {x}_{2} \vert ) \cdot {x}_{2}}{k ( \vert {x}_{1} \vert ) \cdot {x}_{1}} = \frac{β \cdot k ( \vert {x}_{2} \vert )}{k ( \vert {x}_{1} \vert )} \\ and & [ 5 c ] \\ {y}_{2} = \frac{β \cdot k ( \vert {x}_{2} \vert )}{k ( \vert {x}_{1} \vert )} \cdot {y}_{1} & [ 5 d ]\end{matrix}$$

Equation [5d] shows that as the gain k(|x|) may vary as a function of the input amplitude |x| (as shown in Equation [4]), so may the amount of change in the output signal y vary in response to changes in the input signal x. Thus, an exemplary measure of AM-AM distortion may be represented as in the following equation:

$$AM \text{-} AM Distortion = \frac{k ( \vert {x}_{2} \vert )}{k ( \vert {x}_{1} \vert )} \\ where \frac{k ( \vert {x}_{2} \vert )}{k ( \vert {x}_{1} \vert )} \neq 1. \qquad [ 6 ]$$

In addition, the gain k(|x|,T) may also vary as a function of the IC operating temperature, T. Thus, an exemplary measure of AM-AM distortion may be represented as in the following equation:

$$AM \text{-} AM Distortion = \frac{k ( \vert {x}_{2} \vert , {T}_{2} )}{k ( \vert {x}_{1} \vert , {T}_{1} )} \qquad [ 7 ]$$

The output signal from the PA 214 y may have a phase φ relative to the input signal x. When the PA 214 is operating in the linear operating region, the phase may be approximately constant across a range of input amplitudes |x|. When the PA 214 operates in the non-linear operating region, the phase of the output signal y relative to the input signal x, φ(|x|,T), may vary as a function of the input amplitude |x|, and/or of the IC operating temperature, T. Thus, an exemplary measure of AM-PM distortion may be represented as in the following equation:

AM-PM Distortion=φ(|x₂|,T₂)−φ(|x₁|,T₁) [8]

Various embodiments of the invention may comprise a method and system for computing the predistortion function based on a digital input baseband signal, x, generated by the baseband processor 240, and on a digital feedback signal, y, received by the baseband processor 240. The digital input baseband signal, x, may enable generation of an analog RF output signal by the PA 214. The RF output signal generated by the PA 214 may enable generation of the digital feedback signal y. The digital input baseband signal, x, may comprise an I_{BB} component and a Q_{BB} component. An amplitude, |x|, may be computed for the digital input baseband signal, x. The digital feedback signal, y, may comprise an I_{FB} component and a Q_{FB} component. An amplitude, |y| may be computed for the digital feedback signal, y. The predistortion function, p(|y|,T), may represent a function, which enables the digital input baseband signal, x, to be derived from the digital feedback signal, y, as shown in the following equation:

x=p(|y|,T)·y [9]

Thus, given an input signal, x, and an output signal, y, the predistortion function may be computed as shown in the following equation:

$$p ( \vert y \vert , T ) = \frac{x}{y} \qquad [ 10 ]$$

In various other embodiments of the predistortion function may be computed by selecting samples of the digital feedback signal, yᵢ, from within a small range of amplitude values:

γₗ≦|yᵢ|<γₗ₊₁ [11a]

where: (γₗ₊₁−γₗ)<<γₗ;
or by selecting samples of the digital input signal, xᵢ, from within the small range of amplitude values:

γₗ≦|xᵢ|<γₗ₊₁ [11b]

such that the predistortion function may be computed as shown in the following equation:

$$p ( \vert \overline{γ} \vert , {T}_{ref} ) = \frac{{\sum }_{i} {x}_{i}^{H} \cdot {y}_{i}}{{\sum }_{i} {y}_{i}^{H} \cdot {y}_{i}} \qquad [ 12 ]$$

where xᵢ and yᵢ may represent corresponding sets of input and output samples respectively; T_{Ref} may represent a reference temperature at which the samples xᵢ and yᵢ may be taken, γ̅ may represent an average of the amplitude values γₗ, and γₗ₊₁, and xᵢ^{H} and yᵢ^{H} may represent the Hermitian of the samples xᵢ and yᵢ respectively.

In various embodiments of the invention, a lookup table (LUT) may be generated by computing values for the predistortion function, as shown in equation [12], for various ranges of amplitude values, γₗ≦|yᵢ|<γₗ₊₁, and for various operating temperatures, T. The LUT may then be utilized by the baseband processor 240 to predistort the digital input signal, x, to compensate for estimated AM-AM distortion and/or AM-PM distortion produced within the transmitter 123b. The LUT may enable the baseband processor 240 to compensate for estimated non-linear distortion in the transmitter 123b across a range of input signal amplitudes, |x|, and/or across a range of operating temperatures, T.

In various aspects of the invention, the digital input signal, x, may comprise a wideband signal comprising a range of frequencies and/or amplitudes. The range of frequencies and/or amplitudes contained within the wideband signal, also referred to as a training signal, may be selected to meet requirements for applicable standards. An exemplary standard may be spectral density requirements as set forth in IEEE standard 802.11a.

In various other aspects of the invention, the digital input signal, x, may comprise data being transmitted in a communication system, for example, between communicating stations in a WLAN. The range of frequencies and/or amplitudes contained in such normal data communication signals may vary based on the contents of the data being transmitted. In this regard, the frequencies and/or amplitudes may be selected according to applicable standards, for example, IEEE 802.11.

However, utilizing a training signal, or normal data communication signal, in which the frequency and/or amplitude may vary at different time instants may create requirements that a specific sample from the digital input signal xᵢ be time-synchronized to the corresponding sample from the digital feedback signal yᵢ when calculating the predistortion function. Various embodiments of the invention may comprise circuitry, which time-synchronizes each sample from the digital input signal, xᵢ, with each corresponding sample from the digital feedback signal, yᵢ, such that the samples xᵢ and yᵢ may be utilized simultaneously for computing the predistortion function p(|y|,T) as shown in equation [12]. Various embodiments of the invention may also be practiced when the digital input signal, x, comprises a continuous wave (CW) signal, for example one comprising a single frequency.

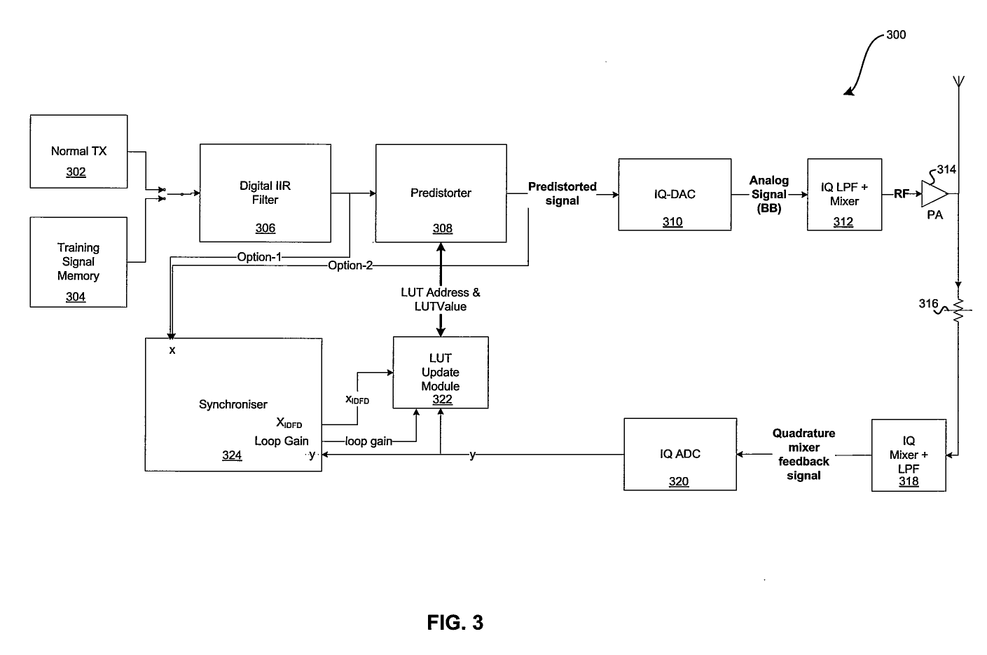

FIG. 3 is a block diagram of an exemplary system for estimating and compensating non-linear distortion in a transmitter using quadrature feedback signals, in accordance with an embodiment of the invention. Referring to FIG. 3, there is shown a transmitter system with feedback 300, The transmitter system with feedback 300 may comprise a normal transmit (TX) block 302, a training signal memory 304, a digital infinite impulse response (IIR) filter block 306, a predistorter block 308, an IQ DAC block 310, an IQ LPF and mixer block 312, a PA 314, a signal attenuator 316, an IQ mixer and LPF block 318, an IQ ADC 320, an LUT update algorithm block 322, and a synchronizer 324.

The normal TX block 302 may comprise suitable logic, circuitry and/or code that may enable generation of data communication signals, which may be transmitted by the transmitter system with feedback 300. In addition, the data communication signals may enable generation of digital feedback signals, which may enable computation of the predistortion function, as shown in equation [12], for example. The normal TX block 302 may comprise memory circuitry, such as the memory 127 (FIG. 1), which may enable storage of data bits, which may be utilized to generate the data communication signals.

The training signal memory block 304 may comprise suitable logic, circuitry and/or code that may enable generation of training signals. The training signals may comprise a wideband signal comprising a plurality of frequencies and/or signal amplitudes. The training signal memory block 304 may also enable generation of a CW signal comprising a single frequency. The training signal may enable generation of digital feedback signals, which may enable computation of the predistortion function, as shown in equation [12], for example. The training signal memory block 304 may comprise memory circuitry, such as the memory 127, which may store one or more data sequences, which may be utilized to enable generation of a corresponding one or more training signals.

The digital IIR filter block 306 may comprise suitable logic, circuitry and/or code that may enable digital smoothing of a received digital input signal. The digital IIR filter block 306 may achieve digital smoothing through oversampling of the received digital input signal with subsequent filtering of the oversampled digital signal.

The predistorter block 308 may comprise suitable logic, circuitry and/or code that may enable digital modification of a received digital input signal based on a predistortion function, such as the predistortion function shown in equation [12], for example. The predistortion function utilized by the predistorter block 308 may generate a predistorted digital signal by modifying an amplitude and/or phase of the received digital input signal based on the predistortion function. The predistorter block 308 may generate the predistortion function based on a stored LUT, which comprises a plurality of LUT elements. The predistorter block 308 may receive LUT elements via an input signal. The input signal may comprise a value for the LUT element and an address location at which the LUT element may be stored within the predistorter block 308. In addition, the predistorter block 308 may receive an input signal comprising an LUT element request and an LUT address. The predistorter block 308 may output a value for an LUT element, which may be stored within the predistorter block 308 at the received LUT address.

The IQ DAC 310 block may be substantially similar to the I DAC 202a and the Q DAC 202b as described in FIG. 2. The IQ LPF and mixer block 312 may be substantially similar to the I LPF 204a, Q LPF 204b, I gm 206a, Q gm 206b, I mixer 208a and Q mixer 208b as described in FIG. 2. The PA 314 may be substantially similar to the RFPGA 210, PAD 212 and PA 214 as described in FIG. 2. The signal attenuation block 316 may be substantially similar to the signal attenuation block 218 as described in FIG. 2.

The IQ mixer and LPF block 318 may comprise suitable logic, circuitry and/or code, which may downconvert a received RF signal and generate a baseband signal comprising an I component and a Q component. The IQ mixer and LPF block 318 may also comprise logic, circuitry and/or code substantially similar to the I LPF 230a, Q LPF 230b, I HPVGA 228a, Q HPVGA 228b, I mixer 226a and Q mixer 226b which may enable filtering of the downconverted I and Q component baseband signals respectively. The IQ ADC 320 block may be substantially similar to the I ADC 232a and Q ADC 232b as described in FIG. 2.

The LUT update algorithm block 322 may comprise suitable logic, circuitry and/or code that may enable generation of LUT element values. The LUT update algorithm block 322 may compute individual LUT element values based on an input signal, x_{IDFD}, an input signal, y and a loop gain value with or without current LUT element value. The current LUT element value may be an input value received in response to an LUT request and LUT address previously output by the LUT update algorithm block 322. The LUT element value computed by the LUT update algorithm block 322 may represent an updated, or replacement, value for the current LUT element value. The LUT update algorithm block 322 may generate an output comprising the computed LUT element value and an LUT address.

The synchronizer 324 may comprise suitable logic, circuitry and/or code that may enable generation of an output signal, x_{IDFD}, and a loop gain value based on a received input signal, x, and a received input signal y. The synchronizer 324 may enable selection of the received input signal x from a plurality of inputs. In an exemplary embodiment of the invention, the synchronizer 324 may receive the input signal, x, from either of two inputs. The output signal, x_{IDFD}, generated by the synchronizer 324 may comprise a time-synchronized version of the selected input signal x. In various embodiments of the invention, the output signal, x_{IDFD}, may be time-synchronized to coincide with the input signal y. For example, if the signal x is generated at a time instant t₀, and the signal y is generated based on the signal x and received by the synchronizer 324 at a time instant t₁, the output signal, x_{IDFD}, may represent a time-delayed version of the signal x, wherein the time delay may be approximately equal to (t₁−t₀). Thus, the value of the input signal, x, at time instant t₀, may be equal to the value of the output signal, x_{IDFD}, at approximately the time instant t₁. Loop gain may represent residual gain introduced into a signal over the course of the transmit path and feedback path. The loop gain output from the synchronizer 324 may be computed to offset the loop gain introduced into the signal in the transmit and feedback paths.

In operation, a processor 125 may enable computation of the predistortion function by selecting a source to generate a input signal xₛ, which may then be utilized to generate the feedback signal y. The processor 125 determine a calibration mode by selecting either the normal TX block 302 or training signal memory block 304 as a source for generating the input signal xₛ. When the normal TX block 302 is selected, the predistortion function may be computed based on normal data communication signal. When the training signal memory block 304 is selected, the predistortion function may be computed based on a training signal.

The digital IIR filter 306 may receive a digital input signal from the selected source and generate an oversampled digital signal, which may be received by the predistorter block 308. The predistorter block 308 may then generate a predistorted digital signal, x_{d}, which may be represented as shown in the following equation:

x_{d}=p·xₒ [13]

where xₒ may represent the oversampled digital signal, and p may represent the predistortion function. At the beginning of a calibration procedure, the value of the predistortion function, p, may be equal to 1. Alternatively, the LUT within the predistorter block 308 may be pre-loaded with values such that the predistortion function is not initially equal to 1.

The IQ DAC block 310 may receive the predistorted signal, x_{d}, and generate an analog baseband signal. The IQ LPF and mixer block 312 may receive the analog baseband signal and generate an analog RF signal. The PA 314 may amplify the analog RF signal. The signal attenuation block 316 may attenuate the amplified analog RF signal. The IQ mixer and LPF block 318 may receive the attenuated signal and generate analog baseband I and Q feedback signals. The IQ ADC may receive the analog baseband I and Q feedback signals and generate digital baseband I and Q feedback signals. The synchronizer 324 may receive the digital baseband I and Q feedback signals as I and Q signal components of the digital feedback signal y.

The processor 125 may configure the synchronizer 324 to receive an input signal, x, from either the output of the digital IIR filter 306, or from the output of the predistorter block 308. When the value of the predistortion function, p=1, the synchronizer 324 may be configured to receive input from the output of the digital IIR filter block 306. When a value, p≠1, has been computed for the predistortion function, the synchronizer 324 may be configured to receive input from the output from the predistorter block 308. In the latter case, the value of the predistortion function, p, may be updated by utilizing a current predistorted signal to compute modifications to the predistortion function, which may be utilized to generate subsequent predistorted signal. The synchronizer 324 may utilize the received input signal, x, and the received digital feedback signal y to compute the time-synchronized signal x_{IDFD}.

From the point at which the signal x is generated to the point at which the feedback signal y is received at the synchronizer 324, a residual offset gain may be a component introduced into the feedback signal by the intervening circuitry within the transmitter and feed back receiver 300. The synchronizer 324 may compute the offset gain as a loop gain.

The LUT update algorithm block 322 may compute individual elements in a LUT based on the computed signal x_{IDFD}, the feedback signal y, and/or the loop gain. The individual LUT elements may represent updated component values of the predistortion function p(|y|,T). For example, a single LUT element may represent a value for the predistortion function for a given input amplitude value, |x|, and/or for a given operating temperature, T_{Ref}.

The LUT update algorithm block 322 may compute an updated component value for the predistortion function by retrieving a current value for the predistortion function component from the predistorter block 308. The LUT update algorithm block 322 may request the component by sending an LUT request indication to the predistorter block 308 along with an LUT address, which may represent a location from which the component may be retrieved within the predistorter block 308. The LUT update algorithm block 322 may subsequently receive the requested component, as the current value for the predistortion function component, from the predistorter block 308.

Based on the current value of the predistortion function component, the current received signal x_{IDFD}, current received signal y, and current received loop gain, the LUT update algorithm block 322 may compute an updated value for the predistortion function component. The LUT update algorithm block 322 may enable storage of the updated value for the predistortion function component within the predistortion block 308 by outputting the updated component value along with the LUT address previously utilized during the request for the current value of the predistortion function component.

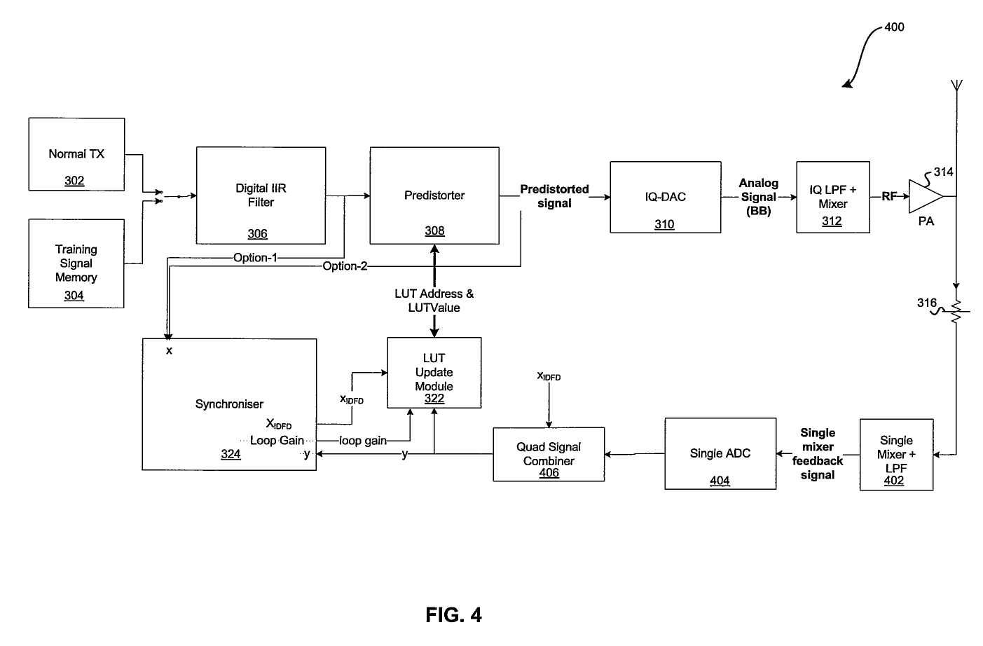

FIG. 4 is a block diagram of an exemplary system for estimating and compensating non-linear distortion in a transmitter using a single feedback signal, in accordance with an embodiment of the invention. Referring to FIG. 4, there is shown a transmitter system with feedback 400, The transmitter system with feedback 300 may comprise a normal transmit (TX) block 302, a training signal memory 304, a digital infinite impulse response (IIR) filter block 306, a predistorter block 308, an IQ DAC block 310, an IQ LPF and mixer block 312, a PA 314, a signal attenuator 316, a single mixer and LPF block 402, a single ADC 404, a quad signal combiner block 406, an LUT update algorithm block 322, and a synchronizer 324.

In comparison to the transmitter system 300, which comprises I and Q feedback mixers in the IQ mixer and LPF block 318 and an IQ ADC block 320, the transmitter system 400 shows an exemplary embodiment of the invention, which comprises a single mixer and LPF block 402, a single ADC block 404, and a quad signal combiner 406.

The single mixer and LPF block 402 may comprise suitable logic, circuitry and/or code that may enable downconversion of a received attenuated RF signal generated from the signal attenuation block 316. The single mixer and LPF block 402 may then enable generation of a single analog baseband signal.

The single ADC 404 may comprise suitable logic, circuitry and/or code that may enable generation of a single digital baseband signal based on a received single analog baseband signal. The single analog baseband signal may comprise an I component signal or a Q component signal at alternating time instants.

The quad signal combiner 406 may comprise suitable logic, circuitry and/or code, which may enable reception of a plurality of samples from a single digital baseband signal, and subsequently generate a quadrature digital baseband signal. The quad signal combiner 406 may receive a sample, yᵢ, from the input single digital baseband signal at a time instant tᵢ. The received sample, yᵢ, may be stored within the quad signal combiner 406. The quad signal combiner 406 may subsequently receive a sample, yₖ, from the input single digital baseband signal at a time instant tₖ. The quad signal combiner 406 may generate a quadrature digital baseband signal, y, as shown in the following equation:

y=yᵢ+j·yₖ [14]

where j=\sqrt{−1}.

In operation, in an exemplary embodiment of the invention, the training signal memory 304 may generate complex input signal samples, xₛ, at a time instant tᵢ, and generate −90 degree rotated signal samples, rot(xₛ), −jxₛ, at a time instant tₖ. The quad signal combiner 406 may receive a real component of the digital baseband feedback signal, yᵢ, at a time t_{i+δ}. The digital baseband feedback signal yᵢ may represent a signal generated in response to the signal xₛ. The quad signal combiner 406 may receive an imaginary component of the digital baseband feedback signal, yₖ, at a time t_{k+δ}. The digital baseband feedback signal yₖ may represent a signal generated in response to the signal rot(xₛ). Based on the received digital baseband feedback signals yᵢ and yₖ, the quad signal combiner 406 may generate a quadrature digital baseband signal as shown in equation [14]. The quad signal combiner 406 may output the quadrature digital baseband signal to the LUT update algorithm block 322 and to the synchronizer block 324 as the signal labeled y in FIG. 4.

In an alternative embodiment of the invention, the normal TX block 302 may generate the input signal xₛ. The quad signal combiner 406 may store a series of observations of the signal x_{IDFD}(tₙ) taken at distinct time instants tₙ. The quad signal combiner 406 may store a series of observations x_{IDFD}(tₙ) order based upon amplitude. For example, the quad signal combiner 406 may store two observations for which:

γₘ<|x_{IDFD}(tᵢ)|<γₘ₊₁ [15a]

and:

γₘ<|x_{IDFD}(tⱼ)|<γₘ₊₁ [15b]

where x_{IDFD}(tᵢ) and x_{IDFD}(tᵢ) may represent observations of the signal x_{IDFD} taken at time instants tᵢ and tⱼ respectively, and γₘ and γₘ₊₁ may represent amplitude values. When the amplitude values γₘ and γₘ₊₁ are approximately equal:

γₘ₊₁−γₘ≈0 [16]

and:

|x_{IDFD}(tᵢ|≈|x_{IDFD}(tⱼ) [17]

Furthermore, the digital baseband feedback signal amplitude received at the quad signal combiner 406 may be represented as in the following equations for a PA 314 gain of k:

|y(tᵢ)|=k·|x_{IDFD}(tᵢ)| [18a]

and:

|y(tⱼ)|=k·|x_{IDFD}(tⱼ)| [18b]

at time instants tᵢ and tⱼ respectively.

In an exemplary embodiment of the invention, the single mixer and LPF 402 may generate an In-phase (I) component of the feedback signal. Thus, at time instants tᵢ and tⱼ the quad signal combiner 406 may receive digital baseband feedback signal observations yₗ(tᵢ) and yₗ(tⱼ), respectively. Based on the received digital baseband feedback signal observations yₗ(tᵢ) and yₗ(tⱼ), and on equations [17], [18a] and [18b], the quad signal combiner 406 may generate values for digital baseband feedback signal observations y_{Q}(tᵢ) and y_{Q}(tⱼ), which may represent Quadrature-phase (Q) components of the feedback signal. Thus, the quad signal combiner 406 may receive a series of observations of the signals x_{IDFD}(tₙ) and yₗ(tₙ), and generate a series of quadrature digital baseband signals, y(tₙ), as shown in the following equation:

y(tₙ)=y_{I}(tₙ)+j·y_{Q}(tₙ) [19]

In various embodiments of the invention, the quad signal combiner 406 may perform the series of steps shown in equations [15a]-[19] for a subsequent range of amplitude values γₘ₊₁ to γₘ₊₂, for example.

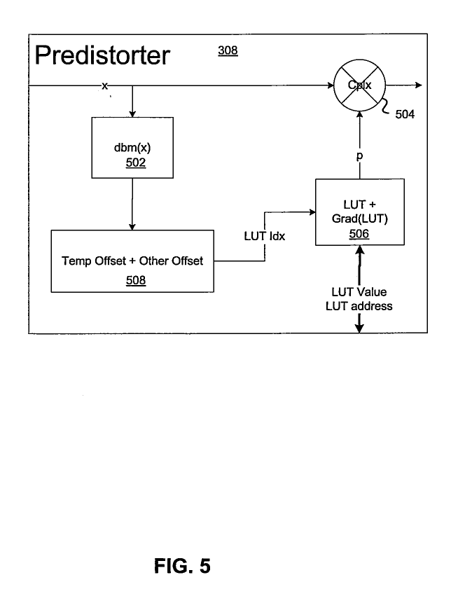

FIG. 5 is an exemplary block diagram of a predistorter, in accordance with an embodiment of the invention. Referring to FIG. 5, there is shown additional detail for the predistorter block 308 (FIG. 3). The predistorter block 308 may comprise a decibel converter block (dbm(x)) 502, a complex multiplication block 504, a lookup table (LUT) 506, and an offset block 508.

The dbm(x) 502 block may comprise suitable logic, circuitry and/or code that may enable reception of an input signal, x, and computation of a decibel (dB) level corresponding to the amplitude of the input signal, x. The dbm(x) block 502 may compute the dB level based on voltage levels or power levels for the input signal x.

The LUT 506 may comprise suitable logic, circuitry and/or code that may enable storage and retrieval of predistortion function component values associated with the predistortion function p. Each predistortion function component may correspond to a level of predistortion for a given input signal magnitude and/or operating temperature. Each predistortion function component may be stored within a distinct location within the LUT 506, which may be accessed based on an LUT address, or LUT index. A predistortion function component accessed based on an LUT index may output the accessed predistortion component value as an output predistortion value, p. The LUT 506 may enable modification of a stored predistortion function component by receiving an input LUT value and/or an input LUT address. The input LUT value and input LUT address may enable the input LUT value to be stored within the LUT 506 at a location specified by the input LUT address. In addition, a predistortion component value may be accessed based on a received input LUT address, wherein the LUT 506 may output the accessed predistortion component value as an output LUT value.

In various embodiments of the invention, the LUT 506 may contain interpolated predistortion function component values and measured predistortion function component values. A measured predistortion function component value may be computed based on one or more samples of an input digital baseband signal, x, and one or more corresponding samples of a digital baseband feedback signal, y. An interpolated predistortion function component value may be computed based on one or more measured predistortion function component values.

The complex multiplication block 504 may enable generation of a predistorted signal by multiplying the value of the input signal, x, and the value of the predistortion function, p. In various embodiments of the invention, the values x and/or p may be represented as complex numbers. The complex multiplication block 504 may enable multiplication between numbers wherein one or both of the numbers may be complex.

The offset block 508 may comprise suitable logic, circuitry and/or code that may enable generation of an LUT index based on the dB level for the input signal x. By generating the LUT index based on the dB level for the input signal x, the offset block 508 may enable the input signal, x, to be modified by the predistortion function, wherein the value for the predistortion function may vary based on the input signal x. In addition, the offset block 508 may enable the LUT index to be modified based on the operating temperature, T. In this regard, the value for the predistortion function may also vary based on the IC operating temperature. Thus, the predistortion function, p, may be represented as p(|x|,T). The offset block 508 may also enable the LUT index to be modified based on other offset factors. For example, the offset block 508 may enable the LUT index to be modified to compensate for gain introduced by other circuitry within the feedback loop.

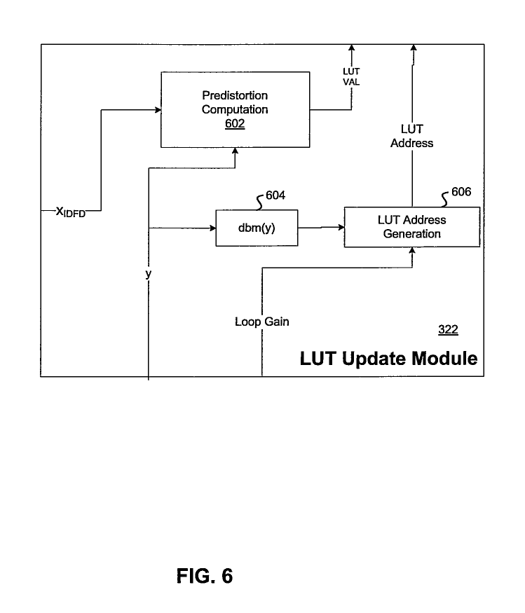

FIG. 6 is an exemplary block diagram of a lookup table update module, in accordance with an embodiment of the invention. Referring to FIG. 6, there is shown additional detail for the LUT update module 322 (FIG. 3). The LUT update module 322 may comprise a predistortion computation block 602, a decibel converter block (dbm(y)) 604, and a LUT address generation block 606. The dbm(y) block 604 may be substantially similar to the dbm(x) block 502.

The predistortion computation block 602 may comprise suitable logic, circuitry and/or code that may enable computation of a predistortion function component values based on an input signal x_{IDFD} and an input signal y. In an exemplary embodiment of the invention, the predistortion computation block 602 may compute a predistortion function p(|x|,T) based on a set of samples of the input signal x_{IDFD} and the input signal y, as described in equations [11a] and [12], the computed predistortion function component value may be output from the predistortion computation block 602 as an LUT value.

The LUT address generation block 606 may comprise suitable logic, circuitry and/or code that may enable generation of an LUT address based on the dB level for the input signal y. The LUT address may be modified based on a loop gain value. With reference to FIG. 3, the signal y may represent a feedback signal in the transmitter system 300. The signal, x, received at the synchronizer 324 may represent an input signal to a feedback loop in the transmitter system 300. The feedback signal y may be produced in response to the signal x. The circuitry, which produces the feedback signal y in response to the signal x may be referred to as a feedback loop.

Referring back to FIG. 6, the input signal to the LUT update module 322, x_{IDFD}, may represent a time-shifted version of the signal, x, which may be time-synchronized to be coincident with the arrival of the feedback signal y at an input to the LUT update module 322. A DC offset may be introduced into the feedback signal y by circuitry within the feedback loop. The loop gain input to the LUT address generation block 606 may enable the LUT address to be modified to compensate for any residual gain in the input signal y.

In operation, the predistortion computation block 602 may compute a LUT value based on amplitude values of the signal y, which may be within a small range of amplitude values as set forth in equation [11a], or based on amplitude values of the signal x, which may be within a small range of amplitude values as set forth in equations [11b], [15a] or [15b]. The LUT address generation block may compute a corresponding LUT address. The LUT update module 322 may output the computed LUT value and corresponding LUT address.

In various embodiments of the invention, the computed LUT value may represent a value for a predistortion component, which may be computed for a given amplitude of the signal, y, and for a given operating temperature, T. The predistortion computation block 602 may compute one or more subsequent LUT values based on subsequent range(s) of amplitude values and/or subsequent operating temperature(s). The LUT address generation block 606 may compute one or more subsequent LUT addresses corresponding to the subsequent LUT value(s).

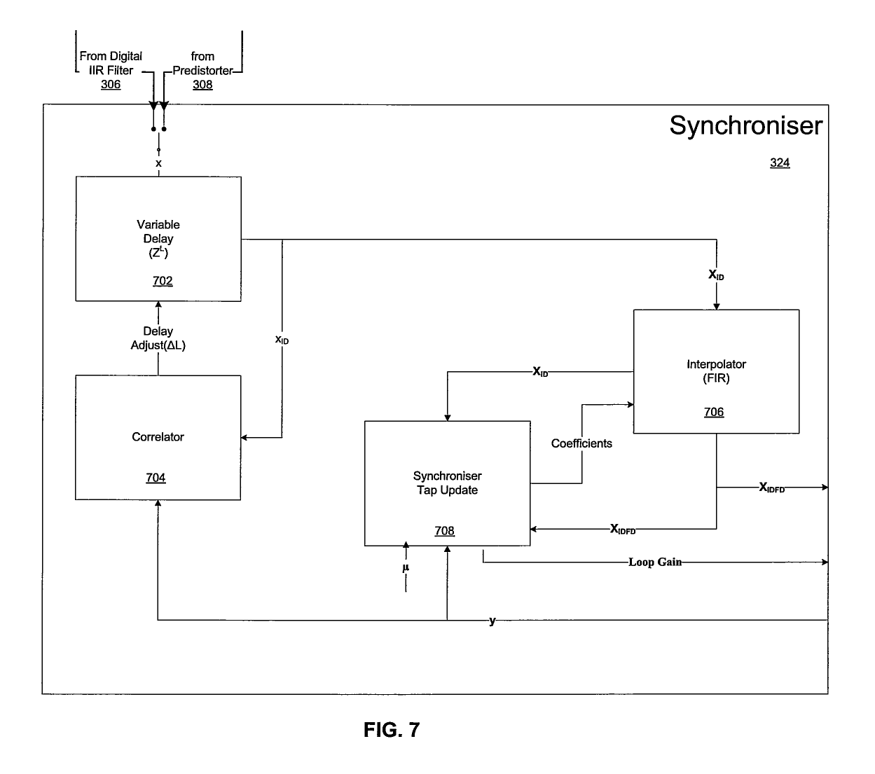

FIG. 7 is an exemplary block diagram of a synchronizer, in accordance with an embodiment of the invention. Referring to FIG. 7, there is shown additional detail for the synchronizer 324 (FIG. 3). The synchronizer 324 may comprise a variable delay block 702, a correlator block 704, an interpolator block 706, and a synchronizer tap update block 708.

The variable delay block 702 may comprise suitable logic, circuitry and/or code that may enable receiving an input signal, x, and generating a time-delayed signal, x_{ID}, based on a delay adjust input signal. The variable delay block 702 may receive the input signal x from any of a plurality of input sources. In an exemplary embodiment of the invention, the variable delay block 702 may select the input signal x from either the digital IIR filter block 306, or from the predistorter 308. The input signal x may comprise a digital signal in which samples, xₙ, may be generated based on a clock rate Rₛₐₘₚ. The time-delayed signal x_{ID} may be referred to as an integer-delayed version of the input signal x in that for an integer delay adjust value, ΔL, the signal x_{ID} may represent a version of the signal, x, delayed by ΔL samples based on the clock rate Rₛₐₘₚ.

The correlator block 704 may comprise suitable logic, circuitry and/or code that may enable computation of a delay adjust value based on the integer delayed signal x_{ID} and an input signal y. The input signal y to the synchronizer 324 may represent the feedback signal y shown in FIG. 3. The correlator block 704 may compute the delay adjust value, ΔL, by comparing the signals x_{ID} and y to determine an amount of time-delay, which may time-synchronize the signal x_{ID} to within one sample time of the signal y, based on the clock rate Rₛₐₘₚ.

The synchronizer tap update block 708 may comprise suitable logic, circuitry and/or code that may enable computation of coefficient values and loop gain values based on the x_{ID} signals and y, and based on the input signal x_{IDFD} and on a convergence coefficient μ. The input signal x_{IDFD} may represent the input signal x_{IDFD} shown in FIG. 3. Based on the inputs μ, x_{ID}, y, and x_{IDFD}, the synchronizer tap update block 708 may compute a set of coefficient values. In addition, the synchronizer tap update block 708 may compute a loop gain value. In an exemplary embodiment of the invention, the loop gain value may comprise a sum of coefficient values. The convergence coefficient μ may determine the rate at which the coefficient values may change in response to the inputs x_{ID}, y, and x_{IDFD}.

The interpolator block 706 may comprise suitable logic, circuitry and/or code that may enable computation of values for the signal x_{IDFD} based on the input signal x_{ID} and the set of coefficient values computed by the synchronizer tap update block 708. The signal x_{IDFD} may represent a time-delayed version of the signal x_{ID}, wherein the time delay between the signals x_{ID} and x_{IDFD} may be less than one sample time based on the clock rate Rₛₐₘₚ. Thus, the signal, x_{IDFD}, may represent an integer-delayed and fractional-delayed version of the signal, x, input to the variable delay block 702. The signal x_{IDFD} may therefore be time-synchronized with the signal y to within a fraction of one sample time. The computed signal x_{IDFD} may be output from the interpolator block 706 and subsequently output from the synchronizer block 324. In an exemplary embodiment of the invention, the interpolator block 706 may implement finite impulse response (FIR) filter circuitry to compute values for the signal x_{IDFD}. The computed loop gain value may be output from the synchronizer tap update block 708 and subsequently output from the synchronizer block 324. The loop gain may represent the interpolator block 706 gain in response to a direct current (DC) input signal.

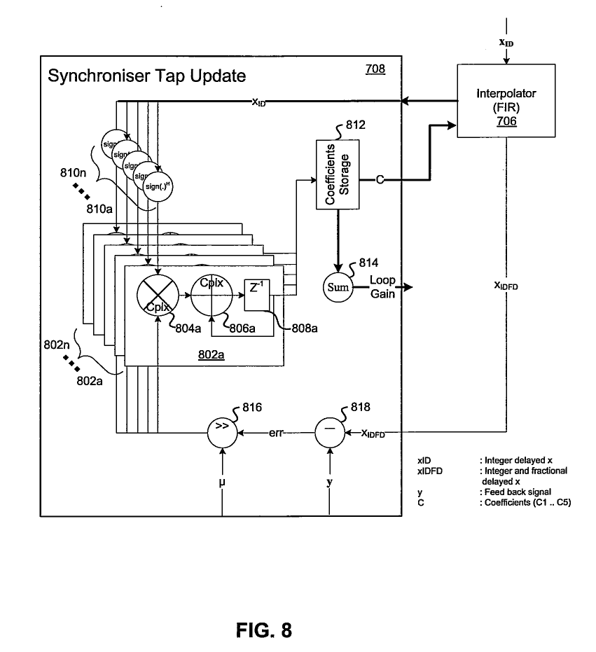

FIG. 8 is an exemplary block diagram of a synchronizer tap update block, in accordance with an embodiment of the invention. Referring to FIG. 8, there is shown additional detail for the synchronizer tap update block 708 and the interpolator 706 (FIG. 7). The synchronizer tap update block 708 may comprise a plurality of coefficient calculation blocks 802a, . . . , and 802n, a plurality of signum function blocks 810a, . . . , and 810ₙ, a coefficient storage block 812, a summation block 814, a bit shift block 816, and an error calculation block 818. The coefficient calculation block 802a may comprise a complex multiplication block 804a, a complex addition block 806a, and a delay block 808a. Each of the remaining coefficient calculation blocks 802a, . . . , and 802n may be substantially similar to the coefficient calculation block 802a.

The signum block 810a may comprise suitable logic, circuitry and/or code that may enable detection of a sign for a complex input signal at time instant tᵢ, x_{ID}(tᵢ). The sign detected by the signum block may comprise a real component, sgn(Re(x_{ID})), and/or an imaginary component sgn(Im(x_{ID})). The signum block 810a may output a Hermitian transform of the detected complex sign, sgn(x_{ID})^{H}. For example, the output Hermitian sign may be represented as shown in the following equation:

sgn(x_{ID})^{H}=sgn(Re(x_{ID}))−j·sgn(Im(x_{ID})) [20]

Each of the remaining signum blocks in the plurality 810a, . . . , and 810n may be substantially similar to the signum block 810a. Each successive signum block may receive a successively time delayed version of the input signal x_{ID}(tᵢ). For example, the signum block 810n may receive a version of the input signal, which may be time delayed by n samples relative to the version of the input signal received by the signum block 810a. For example, the signum block 810n may receive an input signal, x_{ID}(tᵢ₋ₙ).

The error calculation block 818 may comprise suitable logic, circuitry and/or code that may enable computation of an error term based on the input signal x_{IDFD} and the input signal y. The error term, labeled err in FIG. 8, may represent a measure of synchronization error between the signals x_{IDFD} and y, and may be represented as shown in the following equation:

err=y−x_{IDFD} [21]

The bit shift block 816 may comprise suitable logic, circuitry and/or code that may enable binary scaling of the value of the input error signal based on an input scaling factor μ. In an exemplary embodiment of the invention, the bit shift block 816 may implement scaling of a binary error signal value, err, through a binary right shift operation. The number of bits shifted may be determined by the input μ. The output of the bit shift block 816, Frac_err, may be represented as shown in the following equation:

$$Frac\_err = \frac{err}{{2}^{μ}} \qquad [ 22 ]$$

The coefficient calculation block 802a may comprise suitable logic, circuitry and/or code that may enable computation of a coefficient, c₁, based on an input sgn(x_{ID})^{H} value and an input Frac_err value. The complex multiplication block 804a may compute a coefficient increment value, C_inc, by performing a complex multiplication operation on the input values sgn(x_{ID})^{H} and Frac_err. The complex addition block 806a may compute an updated coefficient value, C_upd, by performing a complex addition on the value C_inc and the current coefficient value c₁. The delay block 808a may output the value C_upd with a one sample time delay. Thus, once C_upd is computed in a current sample time interval, the value C_upd may become the coefficient value, c₁, and output from the coefficient calculation block 802a in the next sample time interval.

Each of the remaining coefficient calculation blocks in the plurality 802a, . . . , and 802n may be substantially similar to the coefficient calculation block 802a. Each of the successive coefficient calculation blocks may receive a corresponding sgn(x_{ID})^{H} value from a corresponding one of the signum blocks 810a, . . . , and 810n. Each of the remaining coefficient calculation blocks may also compute a corresponding coefficient value. For example, the coefficient calculation block 802n may compute a coefficient value cₙ. In an exemplary embodiment of the invention, n=5.

The coefficient storage block 812 may comprise suitable logic, circuitry and/or code that may enable storage of the plurality of coefficients c₁, . . . , and cₙ. The plurality of coefficients may be output from the coefficient storage block 812 and from the synchronizer tap update block 708.

The summation block 814 may comprise suitable logic, circuitry and/or code that may enable computation of a loop gain value based on the plurality of computed coefficient values c₁, . . . , and cₙ. In an exemplary embodiment of the invention, the loop gain value may be computed as shown in the following equation:

$$loop gain = {\sum }_{j = 1}^{n} {c}_{j} \qquad [ 23 ]$$

### The computed loop gain value may be output from the summation block 814 and from the synchronizer tap update block 708.

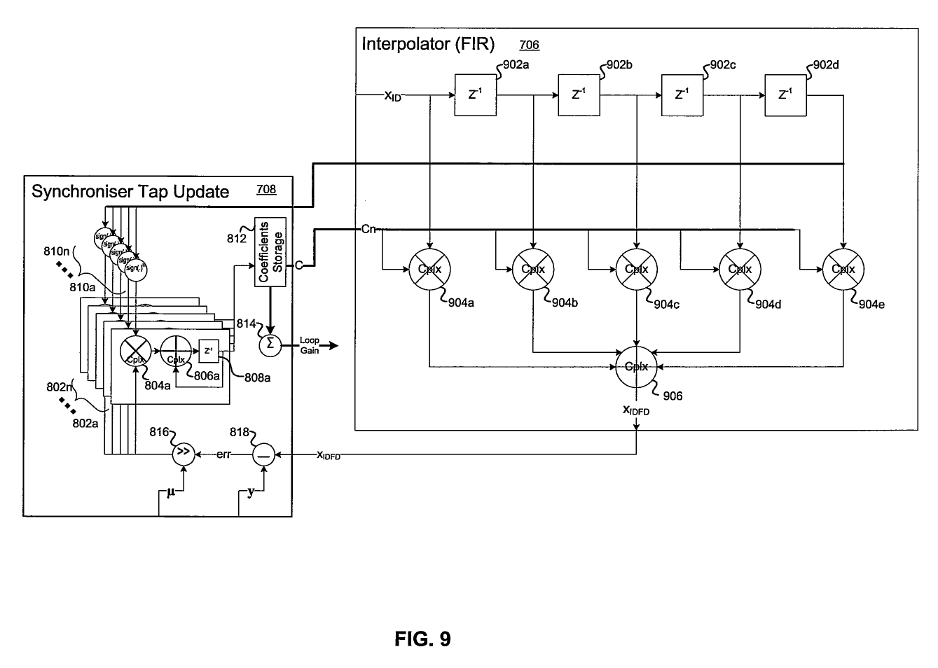

FIG. 9 is an exemplary block diagram of an interpolator block, in accordance with an embodiment of the invention. Referring to FIG. 9, there is shown additional detail for the interpolator 706, and the synchronizer tap update block 708 (FIG. 7). The interpolator block 706 may comprise a plurality of delay blocks 902a, 902b, 902c and 902d, a plurality of complex multiplication blocks 904a, 904b, 904c, 904d and 904e, and a complex addition block 906. The synchronizer tap update block 708 may comprise a plurality of coefficient calculation blocks 802a, . . . , and 802n, a plurality of signum function blocks 810a, . . . , and 810n, a coefficient storage block 812, a summation block 814, a bit shift block 816, and an error calculation block 818. The coefficient calculation block 802a may comprise a complex multiplication block 804a, a complex addition block 806a, and a delay block 808a. Each of the remaining coefficient calculation blocks 802a, . . . , and 802n may be substantially similar to the coefficient calculation block 802a.

Each of the delay blocks 902a, 902b, 902c and 902d may be substantially similar to the delay block 808a. Each of the complex multiplication blocks 904a, 904b, 904c, 904d and 904e may be substantially similar to the complex multiplication block 804a. The complex addition block 906 may be substantially similar to the complex addition block 806a.

Each of the coefficients, c₁, . . . , and cₙ, received as inputs at the interpolator 706 may be input to a corresponding one of the complex multiplication blocks 904a, 904b, 904c, 904d and 904e. In an exemplary embodiment of the invention, the coefficient c₁, may be an input to the complex multiplication block 904a, the coefficient c₂, may be an input to the complex multiplication block 904b, the coefficient C₃, may be an input to the complex multiplication block 904c, the coefficient c₄, may be an input to the complex multiplication block 904d, and the coefficient C₅, may be an input to the complex multiplication block 904e.

The integer-delayed signal x_{ID}(tᵢ) may be received as an input by the interpolator 706. The signal x_{ID}(tᵢ) may be an input to the complex multiplication block 904a. A one sample-time delayed version of the input signal x_{ID}(tᵢ₋₁) may be an input to the complex multiplication block 904b. A two sample-time delayed version of the input signal x_{ID}(tᵢ₋₂) may be an input to the complex multiplication block 904c. A three sample-time delayed version of the input signal x_{ID}(tᵢ₋₃) may be an input to the complex multiplication block 904d. A four sample-time delayed version of the input signal x_{ID}(tᵢ₋₄) may be an input to the complex multiplication block 904e.

Each of the complex multiplication blocks 904a, 904b, 904c, 904d and 904e may compute a complex multiplication product based on the respective inputs. The complex addition block 906 may compute a value for x_{IDFD} by performing a complex addition of the individual complex multiplication products computed by the complex multiplication blocks 904a, 904b, 904c, 904d and 904e. The computed value for x_{IDFD} may be represented as shown in the following equation:

$${x}_{IDFD} ( {t}_{i} ) = {\sum }_{j = 1}^{n} {c}_{j} \cdot {x}_{ID} ( {t}_{i - ( j - 1 )} ) \qquad [ 24 ]$$

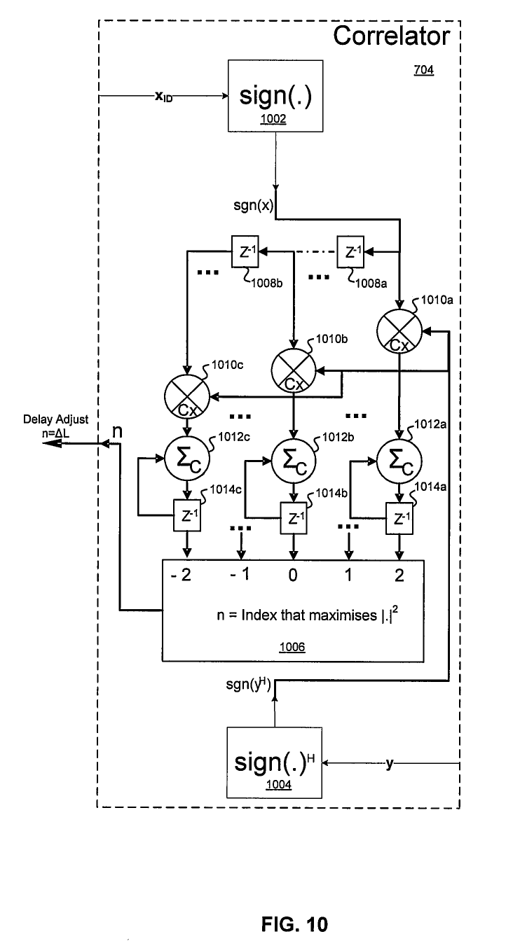

FIG. 10 is an exemplary block diagram of a correlator, in accordance with an embodiment of the invention. Referring to FIG. 10, there is shown additional detail for the correlator 704 (FIG. 7). The correlator 704 may comprise a signum block 1002, a signum block 1004, a delay adjustment computation block 1006, a plurality of delay blocks 1008a and 1008b, and 1014a, 1014b and 1014c, a plurality of complex multiplication blocks 1010a, 1010b and 1010c, and a plurality of complex summation blocks 1012a, 1012b and 1012c.

The signum block 1004 may be substantially similar to the signum block 810a. The delay blocks 1008a and 1008b, and 1014a, 1014b and 1014c may be substantially similar to the delay block 808a, the complex multiplication blocks 1010a, 1010b and 1010c may be substantially similar to the complex multiplication block 804a

The signum block 1002 may comprise suitable logic, circuitry and/or code that may enable detection of a sign for a complex input signal at time instant tᵢ, x_{ID}(tᵢ). The sign detected by the signum block may be represented as shown in the following equation:

sgn(x_{ID})=sgn(Re(x_{ID}))+j·sgn(Im(x_{ID})) [25]

The complex summation block 1012a may comprise suitable logic, circuitry and/or code that may enable computation of an accumulated value resulting from complex additions performed over a series of time instants. The complex summation block 1012a may maintain a current accumulated value. The complex summation block 1012 may perform a complex addition operation on current input values. The complex summation block 1012 may update the accumulated value by adding the result of the current complex addition operation to the current accumulated value. The complex summation block may subsequently update the accumulated value based on addition of subsequent input values.

The delay adjustment computation block 1006 may comprise suitable logic, circuitry and/or code that may enable computation of a delay adjustment value, ΔL, based on a plurality of input values. The delay adjustment computation block 1006 may receive a plurality of input values, each of which may be associated with an index value. As shown in the exemplary FIG. 10, the index values −2, −1, 0, 1 and 2. The delay adjustment computation block 1006 may compute a magnitude squared value for each of the input values and determine a maximum magnitude squared value. Upon determining the input with the maximum magnitude squared value, the index value associated with that input may be determined, n. The delay adjustment computation block 1006 may output a value ΔL=n.

In operation, the correlator block 704 may receive input signals x_{ID}(tᵢ) and y(tᵢ). The signum block 1002 may compute a sign for the input signal x_{ID}(tᵢ) as shown in equation [25]. The signum block 1004 may compute a sign for the input signal y(tᵢ) as shown in equation [20]. The complex multiplication block 1010a may compute a correlation product, CX₂, as shown in the following equation:

CX₂=sgn(x_{ID})·sgn(y)^{H} [26]

The complex summation block 1012a may compute an updated accumulated value, ACC_Upd₂, based on the value CX₂ and a current accumulated value, ACC₂, as shown in the following equation:

ACC_Upd₂=CX₂+ACC₂ [27]

The current accumulated value ACC₂ may be stored in the delay block 1014a. The output from the delay block 1014a may be an input to the complex summation block 1012a. The output from the delay block 1014a may also be an input to the delay adjustment computation block 1006. In the exemplary block diagram shown in FIG. 10, the output from the delay block 1014a may be associated with an index value 2 within the delay adjustment computation block 1006.

The plurality of delay blocks 1008a and 1008b may belong to a chain of delay blocks, each of which may insert a one sample-time delay between the respective input signal and the respective output signal. For example, the delay block 1008a may receive the computed sign for the signal x_{ID}(tᵢ) at the input, while the output of the delay block 1008a may be the computed sign for the signal x_{ID}(tᵢ₋₁). In various embodiments of the invention, there may be one or more additional delay blocks between the delay block 1008a and the delay block 1008b and/or one or more additional delay blocks subsequent to the delay block 1008b. When the delay block 1008b receives a computed sign for the signal x_{ID}(t_{i-q}) at the input, the output of the delay block 1008b may be the computed sign for the signal x_{ID}(t_{i-q-1}), where q may represent the number delay blocks preceding the delay block 1008b in the chain. In an exemplary embodiment of the invention, there may be a total of four delay blocks in the chain of delay blocks.

The complex multiplication block 1010b may compute a correlation product, CX₀, by a method substantially similar to the method shown in equation [26], wherein the value sgn(x_{ID}) may be computed for the signal x_{ID}(tᵢ₋₂). The complex summation block 1012b may compute an updated accumulated value, ACC_Upd₀, based on the value CX₀ and a current accumulated value, ACC₀, by a method substantially similar to the method shown in equation [27]. The current accumulated value ACC₀ may be stored in the delay block 1014b. In the exemplary block diagram shown in FIG. 10, the output from the delay block 1014b may be associated with an index value 0 within the delay adjustment computation block 1006.

The complex multiplication block 1010c may compute a correlation product, CX₋₂, wherein the value sgn(x_{ID}) may be computed for the signal x_{ID}(tᵢ₋₄). The complex summation block 1012_{c} may compute an updated accumulated value, ACC_Upd₋₂, based on the value CX₋₂ and a current accumulated value, ACC₋₂. The current accumulated value ACC₋₂ may be stored in the delay block 1014c. In the exemplary block diagram shown in FIG. 10, the output from the delay block 1014c may be associated with an index value −2 within the delay adjustment computation block 1006.

In the exemplary block diagram shown in FIG. 10, additional computed accumulated values may be associated with index values 1 and −1 within the delay adjustment computation block 1006. The delay adjustment computation block 1006 may determine a maximum magnitude squared value among the plurality of accumulated values associated with the corresponding plurality of index values. The delay adjustment computation block 1006 may output the value of the index, which may be associated with the largest computed magnitude squared value.

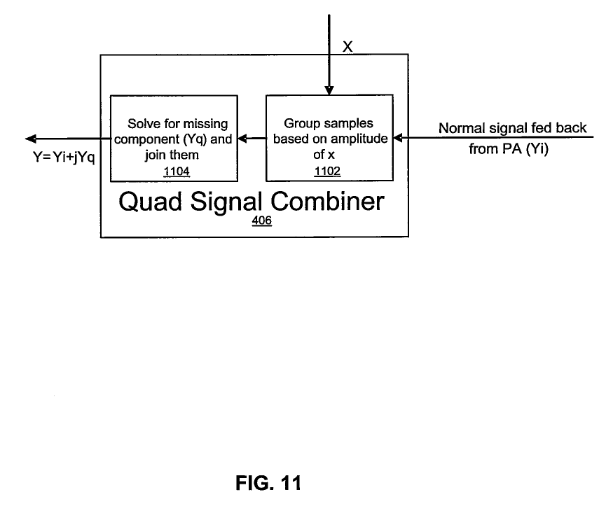

FIG. 11 is a flowchart illustrating exemplary steps for a quad signal combiner with reception of normal data transmission, in accordance with an embodiment of the invention. Referring to FIG. 11, the flowchart may represent the operation of the quad signal combiner 406 (FIG. 4) when the input signal may be generated by the normal TX block 302. In step 1102, the quad signal combiner 406 may receive a series of input samples, x, and may group the samples based on the signal amplitudes of the received input samples as shown in equations [15a] and [15b]. In addition, the quad signal combiner 406 may receive a series of input samples, yₗ, each of which may represent a real component, Re(y), of the complex signal y. In step 1104, the quad signal combiner may determine corresponding values for yQ based on the received samples x and the received samples yₗ. Each of the values y_{Q} may represent an imaginary component, Im(y), of the complex signal y. The quad signal combiner 406 may compute values for samples of the signal y as shown in equation [19].

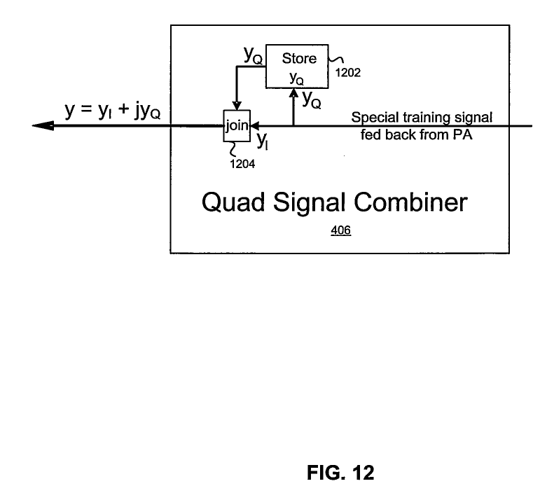

FIG. 12 is a flowchart illustrating exemplary steps for a quad signal combiner with reception of training signals, in accordance with an embodiment of the invention. Referring to FIG. 12, the flowchart may represent the operation of the quad signal combiner 406 (FIG. 4) when the input signal may be generated by the training signal memory block 304. In step 1202, the quad signal combiner 406 may store a received sample of the signal, y, as a signal y_{Q}. I step 1204, the quad signal combiner 406 may combine a succeeding received sample of the signal y as a signal yₗ. The quad signal combiner 406 may compute values for samples of the signal y based on the received samples yₗ and y_{Q} as shown in equation [19].

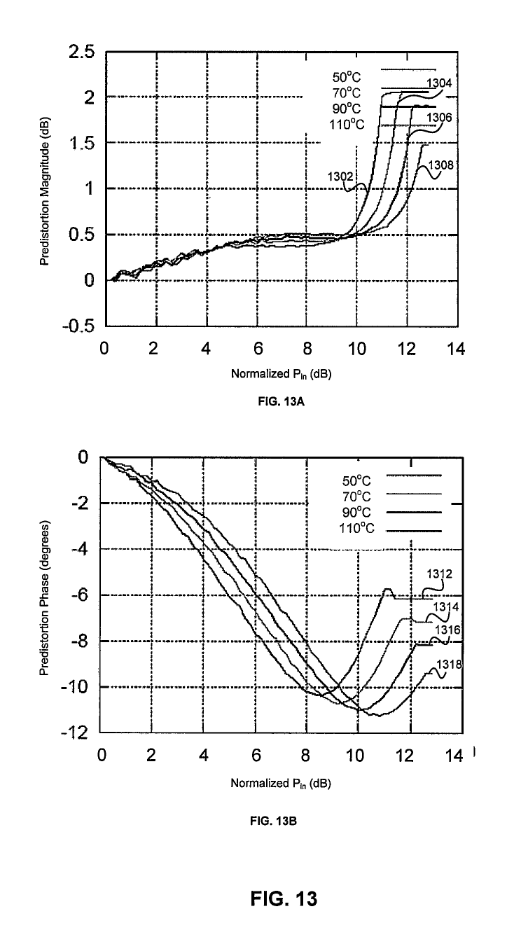

FIG. 13A presents a series of graphs illustrating exemplary predistortion magnitude values, in accordance with an embodiment of the invention. Referring to FIG. 13A, there is shown a plurality of predistortion graphs, 1302, 1304, 1306 and 1308. In FIG. 13A, the vertical axis may represent magnitude values for the predistortion function, p, as measured in dB, for example. The horizontal axis may represent normalized values for input power levels associated with the input signal x, as measured in dB, for example. The values along the horizontal axis may be normalized based on a reference power level for which the PA 214 may operate in a linear operating range. The graph 1302 may represent a predistortion curve computed for a given operating temperature T₁. The graph 1304 may represent a predistortion curve computed for a given operating temperature T₂. The graph 1306 may represent a predistortion curve computed for a given operating temperature T₃. The graph 1308 may represent a predistortion curve computed for a given operating temperature T₄. In an exemplary embodiment of the invention, T₄>T₃>T₂>T₁. Each of the graphs 1302, 1304, 1306 and 1308 may represent stored predistortion function magnitude values in an LUT 506 (FIG. 5).

FIG. 13B presents a series of graphs illustrating exemplary predistortion phase values, in accordance with an embodiment of the invention. Referring to FIG. 13B, there is shown a plurality of predistortion graphs, 1312, 1314, 1316 and 1318. In FIG. 13B, the vertical axis may represent angle values for the predistortion function, p, as measured in degrees, for example. The predistortion graphs 1312, 1314, 1316 and 1318 may correspond to the predistortion graphs 1302, 1304, 1306 and 1308. For example, the graph 1312 may represent the predistortion phase angle corresponding to the predistortion magnitude value shown in graph 1302. The horizontal axis may represent normalized values for input power levels associated with the input signal x, as described in FIG. 13A. The graph 1312 may represent a predistortion curve computed for the operating temperature T₁. The graph 1314 may represent a predistortion curve computed for the operating temperature T₂. The graph 1316 may represent a predistortion curve computed for the operating temperature T₃. The graph 1318 may represent a predistortion curve computed for the operating temperature T₄. In an exemplary embodiment of the invention, T₄>T₃>T₂>T₁. Each of the graphs 1312, 1314, 1316 and 1318 may represent stored predistortion function values in an LUT 506 (FIG. 5).

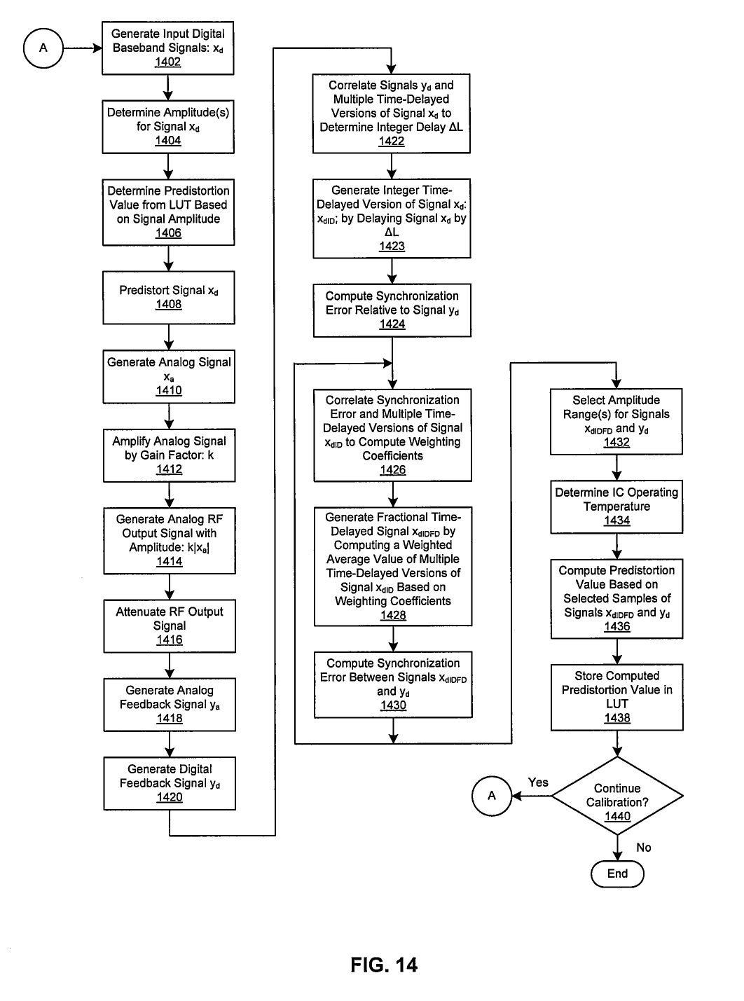

FIG. 14 is a flowchart illustrating exemplary steps for estimating and compensating non-linear distortions in a transmitter using feedback signals, according to an embodiment of the invention. Referring to FIG. 14, in step 1402, the baseband processor 240 may generate a digital baseband signal x_{d}. In step 1404, the baseband processor 240 may determine one or more signal amplitudes for the signal x_{d}. In step 1406, the baseband processor 240 may determine a predistortion value from a lookup table (LUT) 506 based on the signal amplitudes. In step 1408, the predistorter 308 may predistort the signal x_{d} based on the predistortion value.

In step 1410, the transmitter 123b may generate an analog signal xₐ based on the digital signal x_{d}. In step 1412, the PA 214 may amplify the analog signal by a gain factor, k. In step 1414, the PA 214 may generate an analog RF output signal with amplitude k·|xₐ|. In step 1416, the signal attenuation block 316 may generate an attenuated version of the RF output signal. In step 1418, the IQ mixer and LPF 318, or single mixer and LPF 402, may generate an analog feedback signal yₐ. In step 1420, the IQ ADC 320, or single ADC 404 and quad signal combiner 406, may generate a digital feedback signal y_{d}.

In step 1422, the correlator 704 may correlate y_{d} and multiple time-delayed versions of the signal x_{d} to determine an integer delay value ΔL. In step 1423, the variable delay block 702 may generate an integer time-delayed version of the signal x_{d}, x_{dID}, based on the value ΔL. In step 1424, the synchronizer tap update block 708 may compute a synchronization error relative to the signal y_{d}. In step 1426, the synchronizer tap update block 708 may correlate the synchronization error and multiple versions of the time delayed signal x_{dID} to compute weighting coefficients. In step 1428, the interpolator 706 may generate a fractionally time-delayed signal, x_{dIDFD}, by computing a weighted average of multiple time-delayed versions of x_{dID} based on the weighting coefficients. In step 1430, the synchronizer tap update block may update the synchronization error by computing a synchronization error value between signals y_{d} and x_{dIDFD}. Step 1426 may follow step 1430 as the coefficient values may be recomputed. Step 1432 may also follow step 1430 in parallel with step 1426.

In step 1432, an amplitude range may be selected for signals y_{d} and x_{dIDFD}. In step 1434, an IC operating temperature may be determined. In an exemplary embodiment of the invention, this may be determined automatically, for example with a temperature sensor within the transmitter. In step 1436, the LUT update module 322 may compute predistortion values based on selected samples of the signals y_{d} and x_{dIDFD}. In step 1438, the LUT 506 may store the computed predistortion value. Step 1440, may determine whether to continue the calibration procedure. Step 1402 may follow step 1440 when it is determined that the calibration procedure may continue. Otherwise, the calibration procedure may end. Dynamic computation of predistortion values may be enabled by repeating the procedure shown in steps 1402 through 1440 to modify and/or update current predistortion values stored in the LUT 506.

Aspects of a method and system for estimating and compensating non-linear distortion in a transmitter using data signal feedback may comprise a method and system by which predistortion values for compensating for non-linear distortion may be computed based on feedback signals generated in response to wideband input signals. The predistortion values may be computed within an LUT update module 322 based on feedback signals generated in response to wideband input signals. The wideband input signals may comprise a plurality of frequency components and/or signal amplitudes. The predistortion values may be computed by time-synchronizing a wideband input signal generated at a given time instant, and the feedback signal generated at a subsequent time instant in response. A predistortion function may be computed by computing predistortion values for a plurality of signal amplitude values and/or IC operating temperatures. The computed values may be stored in a lookup table 506 and retrieved to predistort subsequent wideband input signals based on the amplitude of the signals and/or the IC operating temperature. Alternatively, a set of predistortion values may be computed and stored for a plurality of signal amplitude values for a single operating temperature during a calibration phase. Then during normal operation the stored predistortion values may be dynamically adjusted based on the IC operating temperature.

The synchronizer 324 may enable synchronization of a plurality of input signals generated at a given time instant so as to be coincident in time with a corresponding plurality of feedback signals, generated in response to the plurality of input signals generated at the given time instant, and detected at a subsequent time instant. One or more predistortion values may be computed based on the plurality of input signals generated at the given time instant and on the corresponding plurality of feedback signals detected at the subsequent time instant. A first time delay value may be computed by calculating a correlation measure between the corresponding plurality of feedback signals detected at the subsequent time instant and a plurality of time-delayed versions of the plurality of input signals generated at the given time instant.

The synchronizer 324 may enable generation of a coarse-grained time-delayed version of the plurality of input signals generated at the given time instant based on the first time delay value. A plurality of weighting coefficients may be computed based on a plurality of time-delayed versions of the coarse-grained time-delayed version of the plurality of input signals generated at the given time instant and a synchronization error value.

The synchronization error value may be computed based on the corresponding plurality of feedback signals detected at the subsequent time instant and on a fine-grained time-delayed version of the plurality of input signals. The fine-grain time-delayed version may be progressively time-adjusted through a sequence of computations.

The synchronizer 324 may enable computation of a fine-grained time-delayed version of the plurality of input signals generated at the given time instant by computing a weighted average of the plurality of time-delayed versions of the coarse-grained time-delayed version of the plurality of input signals generated at the given time instant based on the plurality of weighting coefficients.

The LUT update module 322 may enable computation of the one or more predistortion values based on at least the fine-grained time-delayed version of the plurality of input signals generated at the given time instant and the corresponding plurality of feedback signals detected at the subsequent time instant. A plurality of predistorted input signals may be generated based on a subsequent generated plurality of input signals and on the one or more predistortion values. A subsequent one or more predistortion values may be computed based on said plurality of predistorted input signals.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for estimating distortion in a transmitter circuit in a wireless communications system, the method comprising:
generating one or more input signals, each of said generated one or more input signals comprising one or more frequency components wherein said one or more input signals span a range of signal amplitude levels;
generating a corresponding one or more RF output signals by amplifying each of said generated one or more input signals;
generating a corresponding one or more feedback signals based on said corresponding one or more generated RF output signals; and
computing one or more predistortion values based on said generated one or more input signals and on said corresponding one or more feedback signals.

2. The method according to claim 1, comprising synchronizing said one or more input signals, which are generated at a given time instant, to be coincident in time with said corresponding one or more feedback signals, which are generated in response to said one or more input signals generated at said given time instant, and detected at a subsequent time instant.

3. The method according to claim 2, comprising computing said one or more predistortion values based on said one or more input signals generated at said given time instant and on said corresponding one or more feedback signals detected at said subsequent time instant.

4. The method according to claim 2, comprising computing a first time delay value by calculating a correlation measure between said corresponding one or more feedback signals detected at said subsequent time instant and a plurality of time-delayed versions of said one or more input signals generated at said given time instant.

5. The method according to claim 4, comprising generating a coarse-grained time-delayed version of said one or more input signals generated at said given time instant based on said first time delay value.

6. The method according to claim 5, comprising computing a plurality of weighting coefficients based on a plurality of time-delayed versions of said coarse-grained time-delayed version of said one or more input signals generated at said given time instant and a synchronization error value.

7. The method according to claim 6, comprising computing said synchronization error value based on said corresponding one or more feedback signals detected at said subsequent time instant and on a fine-grained time-delayed version of said one or more input signals.

8. The method according to claim 6, comprising computing a fine-grained time-delayed version of said one or more input signals generated at said given time instant by computing a weighted average of said plurality of time-delayed versions of said coarse-grained time-delayed version of said one or more input signals generated at said given time instant based on said plurality of weighting coefficients.

9. The method according to claim 8, comprising computing said one or more predistortion values based on at least said fine-grained time-delayed version of said one or more input signals generated at said given time instant and said corresponding one or more feedback signals detected at said subsequent time instant.

10. The method according to claim 8, comprising generating said one or more feedback signals based on a portion of each of said corresponding one or more generated RF output signals and said computed fine-grained time-delayed version of said one or more input signals.

11. The method according to claim 10, wherein a magnitude of each of said computed fine-grained time-delayed version of said one or more input signals is approximately equal.

12. The method according to claim 10, wherein said portion of each of said corresponding one or more generated RF output signals comprises one of: a real numerical value and an imaginary numerical value.

13. The method according to claim 8, comprising generating said one or more feedback signals based on a first set of said corresponding one or more generated RF output signals and a second set of said corresponding one or more generated RF output signals.

14. The method according to claim 13, wherein said first set of said corresponding one or more generated RF output signals is generated during a first time duration and said second set of said corresponding one or more generated RF output signals is generated during a second time duration.

15. The method according to claim 14, wherein said second set of said corresponding one or more generated RF output signals is a phase-shifted version of said first set of said corresponding one or more generated RF output signals.

16. The method according to claim 1, comprising computing said one or more predistortion values based on an operating temperature for an integrated circuit that generates said one or more input signals.

17. The method according to claim 1, comprising generating one or more predistorted input signals based on a subsequent generated one or more input signals and on said one or more predistortion values.

18. The method according to claim 17, comprising computing a subsequent one or more predistortion values based on said one or more predistorted input signals.

19. The method according to claim 1, comprising adjusting said one or more predistortion values based on said amplifying.

20. The method according to claim 19, comprising generating one or more predistorted input signals based on a subsequent generated one or more input signals and on said adjusted one or more predistortion values.

21. A system for estimating distortion in a transmitter circuit in a wireless communications system, the system comprising:
one or more circuits that enable generation of one or more input signals, each of said generated one or more input signals comprising a plurality of frequency components wherein said one or more input signals span a range of signal amplitude levels;
said one or more circuits enable generation of a corresponding one or more RF output signals by amplifying each of said generated one or more input signals;
said one or more circuits enable generation of a corresponding one or more feedback signals based on said corresponding one or more generated RF output signals; and
said one or more circuits enable computation of one or more predistortion values based on said generated one or more input signals and on said corresponding one or more feedback signals.

22. The system according to claim 21, wherein said one or more circuits enable synchronization of said one or more input signals, which are generated at a given time instant, so as to be coincident in time with said corresponding one or more feedback signals, which are generated in response to said one or more input signals generated at said given time instant, and detected at a subsequent time instant.

23. The system according to claim 22, wherein said one or more circuits enable computation of said one or more predistortion values based on said one or more input signals generated at said given time instant and on said corresponding one or more feedback signals detected at said subsequent time instant.

24. The system according to claim 22, wherein said one or more circuits enable computation of a first time delay value by calculating a correlation measure between said corresponding one or more feedback signals detected at said subsequent time instant and a plurality of time-delayed versions of said one or more input signals generated at said given time instant.

25. The system according to claim 24, wherein said one or more circuits enable generation of a coarse-grained time-delayed version of said one or more input signals generated at said given time instant based on said first time delay value.

26. The system according to claim 25, wherein said one or more circuits enable computation of a plurality of weighting coefficients based on a plurality of time-delayed versions of said coarse-grained time-delayed version of said one or more input signals generated at said given time instant and a synchronization error value.

27. The system according to claim 26, wherein said one or more circuits enable computation of said synchronization error value based on said corresponding one or more feedback signals detected at said subsequent time instant and on a fine-grained time-delayed version of said one or more input signals.

28. The system according to claim 26, wherein said one or more circuits enable computation of a fine-grained time-delayed version of said one or more input signals generated at said given time instant by computing a weighted average of said plurality of time-delayed versions of said coarse-grained time-delayed version of said one or more input signals generated at said given time instant based on said plurality of weighting coefficients.

29. The system according to claim 28, wherein said one or more circuits enable computation of said one or more predistortion values based on at least said fine-grained time-delayed version of said one or more input signals generated at said given time instant and said corresponding one or more feedback signals detected at said subsequent time instant.

30. The system according to claim 28, wherein said one or more circuits enable generation of said one or more feedback signals based on a portion of each of said corresponding one or more generated RF output signals and said computed fine-grained time-delayed version of said one or more input signals.

31. The system according to claim 30, wherein a magnitude of each of said computed fine-grained time-delayed version of said one or more input signals is approximately equal.

32. The system according to claim 30, wherein said portion of each of said corresponding one or more generated RF output signals comprises one of: a real numerical value and an imaginary numerical value.

33. The system according to claim 28, wherein said one or more circuits enable generation of said one or more feedback signals based on a first set of said corresponding one or more generated RF output signals and a second set of said corresponding one or more generated RF output signals.

34. The system according to claim 33, wherein said first set of said corresponding one or more generated RF output signals is generated during a first time duration and said second set of said corresponding one or more generated RF output signals is generated during a second time duration.

35. The system according to claim 34, wherein said second set of said corresponding one or more generated RF output signals is a phase-shifted version of said first set of said corresponding one or more generated RF output signals.

36. The system according to claim 21, wherein said one or more circuits comprises an integrated circuit and enable computation of said one or more predistortion values based on an operating temperature for said integrated circuit that generates said one or more input signals.

37. The system according to claim 21, wherein said one or more circuits enable generation of a one or more predistorted input signals based on a subsequent generated one or more input signals and on said one or more predistortion values.

38. The system according to claim 37, wherein said one or more circuits enable computation of a subsequent one or more predistortion values based on said one or more predistorted input signals.

39. The system according to claim 21, wherein said one or more circuits enable adjustment of said one or more predistortion values based on said amplifying.

40. The system according to claim 39, wherein said one or more circuits enable generation of one or more predistorted input signals based on a subsequent generated one or more input signals and on said adjusted one or more predistortion values.

41. The system according to claim 21, wherein said one or more circuits comprise at least a baseband processor, a digital infinite impulse response filter, a synchronizer, a predistorter, a lookup table, a memory, a digital to analog converter, an analog to digital converter, a low pass filter, a mixer, a power amplifier and a signal combiner.
